(19) United States
(12) Patent Application Publication
(10) Pub. No.: US 2026/0177753 A1
(43) Pub. Date: Jun. 25, 2026

(54) OPTICAL CONNECTOR, OPTICAL MODULE, PLUG, AND CONNECTION METHOD

(71) Applicants: HAKUSAN INC., Ishikawa (JP); NTT, Inc., Tokyo (JP)

(72) Inventors: Kentaro MATSUDA, Ishikawa (JP); Motohito TAKEZAKI, Ishikawa (JP); Kota SHIKAMA, Tokyo (JP); Yuzo ISHII, Tokyo (JP); Yoshiyuki DOI, Tokyo (JP); Ryo NAGASE, Tokyo (JP)

(21) Appl. No.: 19/126,130

(22) PCT Filed: Nov. 8, 2023
(86) PCT No.: PCT/JP2023/040209

§ 371 Date: Apr. 30, 2025

(30) Foreign Application Priority Data
Nov. 9, 2022 (JP) 2022-179336

(51) Int. Cl. G02B 6/38

(52) U.S. Cl. CPC G02B 6/3825; G02B 6/3865; G02B 6/3869; G02B 6/387; G02B 6/3882; G02B 6/3893

(57) ABSTRACT

[Problem] The purpose of the present invention is to provide an optical connector which has low loss despite being compact and which exhibits little variation in connection loss, an electronic substrate which is connectable to the optical connector, a receptacle of the optical connector, and a connection method for the optical connector. [Solution] An optical connector 10 in which a receptacle 100 and a plug 200 are connectable, wherein: the receptacle 100 is provided with a first plate-shaped ferrule 110 on a connection surface 104; the plug 200 is provided with a connection plate 220 that is provided with a second plate-shaped ferrule 220 on a connection surface 225 and a magnet 230 that can attract the receptacle 100 via the connection plate 220; and the connection plate 220 transmits the magnetic force of the magnet 230 to the receptacle 100 and applies a pressing force from the rear side of the first plate-shaped ferrule 220.

[Solution]

An optical connector 10 in which a receptacle 100 and a plug 200 are connectable, wherein the receptacle 100 is a magnetic body and comprises a first plate-shaped ferrule 110 on a connection surface 104, the plug 200 comprises a connection plate 220 and a magnet, where the connection plate 220 comprises a second plate-shaped ferrule 210 on a connection surface 225 and the magnet can attract the receptacle 100 via the connection plate 220, and the connection plate 220 transmits a magnetic force of the magnet to the receptacle 100, and applies a pressing force from a rear side of the second plate-shaped ferrule 220.

### TECHNICAL FIELD

The present invention relates to an optical connector which optically connects optical waveguide components for transmitting optical signals to each other, an optical module provided with an optical receptacle, a plug of the optical connector, and a connection method for the optical connector.

### BACKGROUND ART

As a method for connecting optical waveguide components such as optical fibers, various methods have been proposed in addition to conventional standardized methods such as MPO.

For example, Patent Literature 1 (International Publication No. WO 2021/111773) discloses a compact optical connection component which retains and presses optical waveguide components to each other using a magnet.

The optical connection component described in Patent Literature 1 is an optical connection component which is connected with another optical connection component, the optical connection component including an optical waveguide component, an alignment component for fixing the optical waveguide component, and a magnetic structure which is integrated with the alignment component, wherein at a connection end face of the alignment component, a positioning structure is provided for determining a relative position between the connection end face and a connection end face of an alignment component included in the another optical connection component.

As an embodiment of Patent Literature 1, there is disclosed a form having a pair of coupling components, the coupling components being each constituted of divided portions. The divided portions face each other with their two faces, one face being magnetized to the N pole while the other face to the S pole so as to be magnetized in an outer peripheral direction of the optical fiber alignment component.

Patent Literature 2 (Japanese Patent Laid-Open No. 2004-029633) discloses an optical fiber connector which exhibits little variation in coupling loss and high reliability and which enables work, such as a connection work and a removal work, to be performed with ease.

The optical fiber connector described in Patent Literature 2 is an optical fiber connector provided with a magnetic body having a hole portion for inserting and fixing an optical fiber, the optical fiber connector including means for reducing the friction coefficient of a connection surface of the magnetic body to be connected with an opposite optical fiber connector. It is configured such that the means for mitigating the impact generated at the time of connecting the opposite optical fiber connector is provided on the side of the connection surface of the magnetic body to be connected with the opposite optical fiber connector, the end face of the optical fiber is positioned inside the connection surface of the magnetic body at the time of not connecting the opposite optical fiber connector, and the end face of the optical fiber comes into contact with the end face of the opposite optical fiber at the time of connecting the opposite optical fiber connector.

Patent Literature 3 (International Publication No. WO 2022/074866) discloses an optical connector that can suppress the wear of a ferrule at the time of attaching and detaching optical connectors to/from each other, wherein optical communications are optically connected by a magnet.

The optical connector described in Patent Literature 3 includes a main body portion, and the main body portion has a first fiber hole which allows insertion of a first optical fiber and a connection end face where the fiber hole is opened and further has a material which generates magnetic force in the inside, and is configured to optically connect the first optical fiber with a second optical fiber by the magnetic force.

As an embodiment of Patent Literature 3 disclosed, the main body has a guide hole for a guide pin, which extends along an axial direction of the fiber hole and opens to the connection end face, and a housing portion for housing a permanent magnet.

Patent Literature 4 (International Publication No. WO 2014/010035) discloses, in a multi-channel optical interconnect which sends and receives high-capacity signals between substrates as optical signals, the substrates having electronic circuits such as integrated circuits incorporated therein, an optical connector which couples, with high efficiency, signals between multiple optical transmission mediums such as optical fibers and optical waveguides, and an optical connector connection method which achieves an easy process for the connection and the disconnection of the optical connector.

The optical connector described in Patent Literature 4 is an optical connector including a first connector member and a second connector member, wherein the first connector member has a casing, a through-hole for an optical fiber passing through the casing, a fixing portion which fixes the optical fiber provided inside the casing, and a first alignment portion provided on the surface of the casing, the second connector member has a casing, a through-hole for an optical fiber passing through the casing, a fixing portion which fixes the optical fiber provided inside the casing, and a second alignment portion provided on the surface of the casing, a magnet is provided in a region of the surface of the first alignment portion which is connected to the second alignment portion, a magnetic body is provided in a region of the surface of the second alignment portion which is connected to the magnet, the magnet of the first connector member is connected with the magnetic body of the second connector member to connect the connector members to each other, so that the optical fiber fixed to the first connector member and the optical fiber fixed to the second connector member are optically connected; and the first alignment portion further has magnetic force shielding means.

### CITATION LIST

### Patent Literature

Patent Literature 1: International Publication No. WO 2021/111773
Patent Literature 2: Japanese Patent Laid-Open No. 2004-029633
Patent Literature 3: International Publication No. WO 2022/074866
Patent Literature 4: International Publication No. WO 2014/010035

### Non Patent Literature

Non Patent Literature 1: K. Shikama. N. Sato, R. Nagase, Y. Doi, H. Tanobe, S. Tsunashima, and Y. Ishii, “Ultra-compact Multi-fiber Connector with Magnetic Physical Contact” in Proc. Optical Fiber Communication Conference 2022, p. WIE. 4. (2022)

### SUMMARY OF INVENTION

### Technical Problem

The optical connectors described in Patent Literatures 1 to 4 and Non-Patent Literature 1 all cause the optical waveguide components to come into contact with each other using the attraction force of magnets. However, the attraction force of magnets is strongly influenced by the distance between the magnets. Therefore, in order to obtain, from the magnet, the pressing force sufficient for optical communication, it was necessary to keep the magnets in a sufficiently close distance, which posed a problem that slight variation in distance between the magnets greatly influenced the variation in connection loss. Particularly, tolerances or the like generated in the process of manufacturing optical connectors influenced the variation in distance, as a result of which variation in connection loss was greatly affected.

In recent years, with the increase in capacity and speed of communication, the variation in connection loss of the optical connectors becomes significant enough to exert a major impact on communication performance. Furthermore, in high-density communication using multi-fiber ferrules, it is necessary to apply uniform pressing force to the entire connection end face.

Particularly, in the case where optical connection terminals are installed on electronic substrates such as servers to perform communication between servers or between substrates, that is, to perform high-speed and large-capacity information communication using optical communication, the control of the contact force at the connection end face is an important technology.

Patent Literature 2 describes an optical fiber connector with a buffer material arranged thereon to mitigate the impact that is generated at the time of connection. However, when the buffer material is arranged between two magnetic bodies, precise control of the positions of the magnetic bodies is compromised, which makes it difficult to control the connection loss of the optical connector.

Patent Literature 3 describes an example where a permanent magnet is arranged in a guide hole of an MT ferrule. However, in order to achieve high-density and high-capacity optical communication using a multi-fiber MT ferrule, a contact force of several N to a few tens of N is required, and it was difficult to apply such a large force on the connection end face.

In Patent Document 4, a mechanism for rotating the magnet in the alignment portion is provided in order to simplify the disconnection of the optical connector. However, precise position control of the magnet is difficult.

An object of the present aspect is to provide an optical connector which has low loss despite being compact and which exhibits little variation in connection loss, an optical module which is connectable to the optical connector, a plug of the optical connector, and a connection method for the optical connector.

Another object of the present aspect is to provide an optical connector which can perform high-density and high-capacity optical communication, an optical module which is connectable to the optical connector, a plug of the optical connector, and a connection method for the optical connector.

### Solution to Problem

(1)

An optical connector according to first aspect is the optical connector in which a receptacle and a plug are connectable, wherein the receptacle is a magnetic body and is provided with a first plate-shaped ferrule on a connection surface, the plug is provided with a connection plate that is provided with a second plate-shaped ferrule on a connection surface and a magnet which can attract the receptacle via the connection plate, and the connection plate transmits a magnetic force of the magnet to the receptacle, and applies a pressing force from a rear side of the first plate-shaped ferrule.

The connection surfaces of the receptacle and the plug are each provided with a plate-shaped ferrule, and when the plate-shaped ferrules receive an attraction force of the magnet from the rear side, a uniform and sufficient contact force can be applied to the connection end faces of the ferrules while a separation distance r between the connection surface of the receptacle and the connection surface of the plug can be minimized.

Since the magnet provided in the plug applies the pressing force to the first plate-shaped ferrule through the connection plate, the arrangement position of the first plate-shaped ferrule can be precisely controlled based on the design of the connection plate. In other words, even in the case of using a rare earth magnet, which tends to crack and has a large sintering shrinkage, a precise and uniform contact force can be applied to the plate-shaped ferrules by using the connection plate.

In addition, since the connection plate is configured to transmit the magnetic force of the magnet to the receptacle, the distance between the plug and the receptacle can be minimized, and this can minimize the reduction in attraction force of the magnet.

The connection plate that is provided with the plate-shaped ferrules can mitigate the impact at the time of connecting the connector and can also minimize the influence of a tolerance due to processing of the magnet. Since the plate-shaped ferrules receive stress from the rear side, it is possible to control the separation distance r to be minimum with high precision as compared with the case of conventional cube-shaped ferrules.

Moreover, as compared with the case of using conventional cube-shaped ferrules, it is possible to form the plug with fewer components and with superior manufacturability and assemblability. Since the components are fewer, tolerance management can be simplified, which makes it possible to control the separation distance r with high precision.

General optical connectors, such as MPO, apply the pressing force by the spring force, which made it relatively easy to design the pressing force required for the connection end face of the optical connection, though there was a problem that miniaturization is difficult. On the other hand, it is difficult to design the pressing force when the attraction force of a magnet is used, and there is a problem that the attraction force is greatly influenced by the type of the magnet, the shape and size of the magnet, the arrangement position of the magnet, or the like.

Specifically, assuming that the strength of the magnetic poles are m₁ and m₂ [Wb], the distance between the two magnetic poles is r, and the permeability in the vacuum is μ₀, the strength of the force F[N] is expressed by “F=(¼·πμ₀) (m₁m₂/r²), which indicates that the force acting on the magnet is proportional to the product of the strength of the magnetic poles and is inversely proportional to the square of the distance. Therefore, in order to obtain a large force by a relatively small magnet, the distance r needs to be particularly small.

In addition, when the distance r varies 10%, an acting force varies 20%. Therefore, when the large force F is obtained by decreasing the distance r, the variation in distance r increases, and therefore the variation in distance r need to be minimized.

The connection plate of the present aspect is configured to transmit the magnetic force of the magnet to the receptacle, and the optical waveguide components come into contact with each other between the second plate-shaped ferrule provided on the connection plate and the first plate-shaped ferrule provided on the connection surface of the receptacle. This makes it possible to accurately determine the relative distance between the connection surface of the receptacle and the connection end face of the first plate-shaped ferrule and the relative distance between the connection surface of the plug and the connection end face of the second plate-shaped ferrule, so that the gap (separation distance r) of a magnetic circuit can be precisely and minimally controlled.

Therefore, even when the pressing force is applied by the magnetic force, sufficient attraction force can be obtained. Since a parallel and uniform contact force can be applied to the optical waveguides of the ferrules which are in contact with each other, it is possible to provide an optical connector which has low loss despite being compact and which exhibits little variation in connection loss.

Note that the magnetic bodies used herein are those containing hard magnetic materials and/or soft magnetic materials. The rear side of the ferrule refers to the back surface that is opposite to the connection end face. The optical waveguide component refers to a component or an element which can transmit optical signals, such as optical fibers, optical waveguides, and optical communication elements. Examples of the optical waveguide may include glass optical waveguides, polymer optical waveguides, and film-type optical waveguides.

(2)

The optical connector according to second aspect is the optical connector according to the first aspect, wherein the magnet may include a first magnet and a second magnet which have an N pole and an S pole along a longitudinal direction of an optical waveguide component and which are configured to face each other and to incorporate the optical waveguide component, and the connection plate may be a magnetic body and be arranged so that an attraction force acts between the first and second magnets and the receptacle.

This makes it possible to configure a magnetic circuit made of a path including the first magnet, the connection plate, the receptacle, the connection plate, the second magnet, and the first magnet at the time of connecting the optical connector (see FIG. 1). Specifically, the magnetic force reaches the receptacle via the connection plate from the first magnet having the N and S poles along the longitudinal direction of the optical waveguide component. The magnetic force also reaches the second magnet having the S and N poles along the longitudinal direction of the optical waveguide component via the connection plate from the receptacle.

Therefore, since the magnetic circuit is configured by connecting the receptacle and the plug of the optical connector, lines of magnetic force are less prone to leakage, and a sufficient contact force can be applied to the connection end faces even when the optical connector is compact.

Particularly, since the magnetic circuit is configured within the optical connector, the contact force on the connection end faces can be determined mainly based on the separation distance r (gap) between the connection surface of the receptacle and the connection surface of the connection plate, and therefore the contact force required for the optical connection can be designed.

In addition, since the magnetic circuit is configured only when the receptacle and the plug are connected, the magnetic force is kept to a certain level until the plug is connected to the receptacle, and once the plug is connected to the receptacle, a strong magnetic circuit is configured so that a sufficient contact force can be obtained despite a compact size.

(3)

The optical connector according to third aspect is the optical connector according to the first aspect or the second aspect, further including a yoke arranged on a side of the magnet opposite to the connection plate, wherein the yoke may be a magnetic body which is arranged so that an attraction force acts between the first and second magnets.

This makes it possible to configure a magnetic circuit made of a path including the first magnet, the connection plate, the receptacle, the connection plate, the second magnet, and the yoke at the time of connecting the optical connector (see FIG. 1). Specifically, the magnetic force reaches the receptacle via the connection plate from the first magnet having the N and S poles along the longitudinal direction of the optical waveguide component. The magnetic force also reaches the second magnet having the S and N poles along the longitudinal direction of the optical waveguide component via the connection plate from the receptacle. The magnetic force further reaches the first magnet via the yoke, so that a closed magnetic circuit is configured.

Therefore, since the closed magnetic circuit is configured by connecting the receptacle and the plug of the optical connector, lines of magnetic force are less prone to leakage, and a sufficient contact force can be applied to the connection end faces even when the optical connector is compact.

(4)

The optical connector according to fourth aspect is the optical connector according to any one of the first aspect to the third aspects, wherein the connection plate may come into contact with the first magnet and the second magnet, and a slit may be formed between a contact portion of the first magnet and a contact portion of the second magnet.

Note that the magnet may include the first magnet and the second magnet which have an N pole and an S pole along a longitudinal direction of the optical waveguide component and which are configured to face each other and to incorporate the optical waveguide component.

This makes it possible to reliably configure a magnetic circuit made of a path including the first magnet, the receptacle, and the second magnet at the time of connecting the optical connector. Specifically, the connection plate is present between the first magnet and the receptacle and between the receptacle and the second magnet. Since the connection plate has a role of transmitting magnetism, there is a risk of forming a circuit (shortcut) in which magnetism flows directly from the first magnet to the second magnet.

As a solution, a slit may be provided between the contact portion of the first magnet and the contact portion of the second magnet to restrict a magnetic circuit that is a shortcut and reliably configure a magnetic circuit that is via the receptacle so that a stronger contact force can be applied to the optical connection end face.

(5)

The optical connector according to fifth aspect is the optical connector according to any one of the first aspect to the fourth aspects, wherein a length of one side of the first plate-shaped ferrule may be 50% or more of a length of one side of the connection plate, and a length of another side that is perpendicular to the one side of the first plate-shaped ferrule may be 50% or more of a length of another side that is perpendicular to the one side of the connection plate.

In this case, the first plate-shaped ferrule and the second plate-shaped ferrule preferably have identical dimensions.

In case the plug is connected to the receptacle, the receptacle and the plug are made to come close to each other, and once a magnetic circuit starts to be formed, the magnetic force of both the receptacle and the plug rapidly increases and attracts each other with a strong force. Therefore, when the plug is connected to the receptacle, the rapid increase in magnetic force may disturb the balance of the magnetic force, which may cause collision of only one ends or one sides, resulting in the receptacle and the plug not in parallel to each other.

Accordingly, in the connection plate which forms a magnetic circuit, setting the length of one side of the plate-shaped ferrule to be half or more of the length of the connection plate can prevent such connection that makes the separation distance r at one end or one side of the connection plate to be zero at the time of connecting the optical connector. As a result, the first plate-shaped ferrule and the second plate-shaped ferrule can be tightly coupled in parallel and be reliably and stably connected.

(6)

The optical connector according to sixth aspect is the optical connector according to any one of the first aspect to the fifth aspects, wherein the plug may be further provided with a protection component which is adjacent to the connection plate and which has an insertion hole into which the optical waveguide component can be inserted, and a boot which retains in parallel a plurality of optical waveguide components extending from the second plate-shaped ferrule, the first plate-shaped ferrule and the second plate-shaped ferrule may each have an insertion hole in which the plurality of optical waveguide components are mountable and a guide hole for insertion of a guide pin, the receptacle may have a recess portion for fitting the first plate-shaped ferrule and a hole portion into which the optical waveguide components can be inserted, the connection plate may have a recess portion for fitting the second plate-shaped ferrule and a hole portion into which the optical waveguide components can be inserted, and the magnet may be arranged symmetrically with respect to a longitudinal central axis of the optical waveguide components so that the magnet is in a U-shape.

Note that the magnet may include the first magnet and the second magnet which have an N pole and an S pole along a longitudinal direction of the optical waveguide components and which are configured to face each other and to incorporate the optical waveguide components.

In addition, the longitudinal direction of the optical waveguide components is the same direction as the connection direction of the optical waveguide components, and the longitudinal central axis refers to a perpendicular line passing through the center of the connection surface of the optical waveguide components. Since the first magnet and the second magnet are symmetrically spaced apart with respect to the longitudinal central axis of the optical waveguide components, the attraction force of the magnet is evenly applied to the entire connection surface of the optical waveguide components.

Since the receptacle and the connection plate each have the recess portion for fitting each of their plate-shaped ferrules and the hole portion into which the optical waveguide components can be inserted, the depth of the recess portion and the thickness of the plate-shaped ferrules can be precisely designed and processed. This allows precise control of a protrusion distance of the connection end faces of the plate-shaped ferrules to the respective connection surfaces of the receptacle and the connection plate. Therefore, it is possible to precisely control the separation distance r (gap) between the connection surface of the receptacle and the connection surface of the connection plate. This makes it possible to minimize the separation distance r of the magnetic materials (the distance at which lines of magnetic force are formed in space), while minimizing the variation in separation distance r. Therefore, it is possible to minimize the variation in loss while restraining the connection loss.

In order to reliably fix the plurality of optical waveguide components to the plate-shaped ferrules, an adhesive pool may be formed on the rear surface of the plate-shaped ferrules. Since the recess portions of the receptacle and the connection plate are provided with the hole portions into which the optical waveguide components can be inserted, the adhesive pool is inserted into the hole portions to prevent interference between the recess portions and the adhesive pool when the adhesive pool is formed. Therefore, the pressing force can reliably be applied to the plate-shaped ferrules.

Since the protection component, having an insertion hole into which the optical waveguide components can be inserted, is arranged adjacent to the connection plate, the adjacently arranged connection plate and the U-shaped first and second magnets can be accurately and easily arranged with the protection component as a center, the protection component being formed so as to cover the optical waveguide components in the axial direction.

Furthermore, since the first magnet and the second magnet are symmetrically arranged with respect to the longitudinal central axis of the optical waveguide components, two bar magnets can be arranged in parallel to the axial direction of the optical waveguide components and evenly separated from the axial center. This allows an equal contact force to be applied to the connection end face of the connection plate.

Note that the first magnet and the second magnet are arranged facing each other in a U-shaped state with their magnetic poles opposite to each other, so that they are fixed while attracting each other through the protection component. In this case, in terms of the ease of assembly, the protection component is preferably a non-magnetic body made of aluminum, plastic, or the like.

(7)

The optical connector according to seventh aspect is the optical connector according to any one of the first aspect to the sixth aspects, wherein the connection plate may have a thickness of 0.3 mm or more to 5 mm or less.

This makes it possible to more effectively configure a magnetic circuit made of a path including the first magnet, the connection plate, the receptacle, the connection plate, and the second magnet at the time of connecting the optical connector.

Specifically, when the thickness t of the connection plate is set to an upper limit or less, the magnetism generated from the end portion of the first magnet can be transmitted more reliably to the receptacle, so that even stronger contact force can be applied to the end face of the optical connection. When the thickness t of the connection plate is set to a lower limit or more, processing accuracy can be improved while maintaining mechanical strength. As the thickness of the connection plate is within the prescribed range, the pressing force equivalent to the spring force of the existing MPO connectors can be obtained.

(8)

The optical connector according to eighth aspect is the optical connector according to any one of the first aspect to the seventh aspects, wherein the first plate-shaped ferrule and the second plate-shaped ferrule may be constituted of a machinable ceramic with a thickness of 0.3 mm or more to 3 mm or less.

Optical connection components with higher heat resistance than typical resin ferrules can be designed by using machinable ceramics as the material for the plate-shaped ferrules. As a result, even when an optical connector is provided directly on the substrate close to electronic components, the fluctuation of a fiber insertion hole can be restrained and the effect on connection loss can be prevented. Therefore, a high-density optical line can be mounted at the position close to the electronic components, and therefore high-speed and large-capacity information processing can be achieved.

When ceramics are used as ferrules, it is possible to avoid manufacturing restrictions associated with resin molding, as in the case of conventional resin ferrules, and therefore more compact and thinner ferrules can be formed. Moreover, since the plate of ceramics with high mechanical strength and heat resistance is processed by machining, it becomes possible to increase the number of optical waveguide components for high-density optical connection, so that high-speed and large-capacity communications can be connected.

Furthermore, since the thickness of the plate-shaped ferrules is within a prescribed range, the main bodies of the plate-shaped ferrules can be polished without breaking.

As a result, the thickness of the plate-shaped ferrules can be precisely processed, so that the separation distance r between the connection surface of the connection plate and the connection surface of the receptacle can be precisely adjusted. Therefore, the contact force of the optical connection end faces can be precisely controlled.

(9)

The optical connector according to ninth aspect is the optical connector according to any one of the first aspect to the eighth aspects, wherein the first magnet and the second magnet may be symmetrically spaced apart with respect to the longitudinal central axis of the optical waveguide components, and the slit may have a width that is equal to the distance of a gap between the first magnet and the second magnet, and be provided from each of an upper end portion and a lower end portion of the connection plate to a position of the second plate-shaped ferrule.

Note that the magnet may include the first magnet and the second magnet which have an N pole and an S pole along the longitudinal direction of the optical waveguide components and which are configured to face each other and to incorporate the optical waveguide components. The connection plate may come into contact with the first magnet and the second magnet, and the slit may be formed between a contact portion of the first magnet and a contact portion of the second magnet.

As a result, since the first magnet and the second magnet are symmetrically arranged with respect to the longitudinal central axis of the optical waveguide components, two bar magnets can be arranged in parallel to the axial direction of the optical waveguide components and evenly separated from the axis. Moreover, since the connection plate with which the two magnets come into contact has the slit formed with a sufficient length, it is possible to sufficiently restrain the formation of the magnetic circuit as a shortcut and to more reliably form a magnetic circuit made of a path including the first magnet, the receptacle, and the second magnet.

Therefore, the pressing force can be applied to the connection plate with an even and sufficient force.

(10)

The optical connector according to tenth aspect is the optical connector according to any one of the first aspect to the ninth aspects, wherein the protection component may be formed of a non-magnetic material and has, on an upper surface and a lower surface, protruding portions protruding in parallel to a longitudinal central axis of the optical waveguide component, and the protruding portions may be formed so as to further extend from an end portion of the protection component and be configured to be inserted into the slit.

Note that the plug may be further provided with a protection component having an insertion hole into which the optical waveguide components can be inserted. The connection plate may come into contact with the first magnet and the second magnet, and the slit may be formed between a contact portion of the first magnet and a contact portion of the second magnet.

The protection component is configured to cover the optical waveguide components inside, with the magnet arranged around the protection component, and the connection plate is further arranged on the side of the connection end face of the plug. In other words, each component member of the plug can be positioned with the protection component as a center.

The protruding portions of the protection component, which protrude in parallel to the longitudinal central axis of the optical waveguide components while being in contact with the connection plate, are inserted into the slit of the connection plate, so that the magnet can accurately be arranged with respect to the connection plate.

Since the protection component is a non-magnetic body made of aluminum, plastic, or other materials, the plug is easily assembled even when the first magnet and the second magnet are strong rare earth magnets.

(11)

The optical connector according to eleventh aspect is the optical connector according to any one of the first aspect to the tenth aspects, wherein the connection plate may have a recess portion on the connection surface, and the second plate-shaped ferrule may be fitted into the recess portion and be applied with a pressing force from a rear side.

As a result, the plate-shaped ferrules are fixed to the connection plate as a float structure without the necessity of adhesives or the like, and are applied with the pressing force. Therefore, the resistance to external force increases and the precision of the separation distance r (gap) can be enhanced. In addition, the number of components can be reduced and the required tolerance can be lowered. The separation distance r can be controlled with high precision.

(12)

The optical connector according to twelfth aspect is the optical connector according to any one of the first aspect to the eleventh aspects, wherein a separation distance between the connection surface of the receptacle and the connection surface of the connection plate may be 0.5 mm or less, and the number of fibers of the optical waveguide component to be connected in each of the first plate-shaped ferrule and the second plate-shaped ferrule may be 8 or more to 80 or less.

Since the separation distance r between the connection surface of the receptacle and the connection surface of the connection plate is 0.5 mm or less, sufficient pressing force can be obtained when typical rare earth magnets are used, which makes it possible to suitably perform high-density optical communication in which the number of fibers of the optical waveguide component to be connected is 8 or more to 80 or less. Note that the lower limit of the separation distance r is preferably set to 0.02 mm or more in terms of connectivity.

(13)

An optical module according to thirteenth aspect is an electronic substrate module which is connectable to the optical connector according to any one of the first aspect to the twelfth aspects, the optical module including a receptacle.

By installing an modularized optical connector directly on the electronic substrate, a high-density optical line can be mounted at the position close to electronic components. This makes it possible to perform high-speed and large-capacity information processing.

(14)

A plug according to fourteenth aspect is the optical connector according to the first aspect to the twelfth aspects, wherein the optical connector is connectable to the receptacle.

When magnetic force is used as the pressing force of the optical connector, a small difference in distance becomes a large difference in pressing force. When variation in contact force is generated on the end face of the optical connection, it leads to a large variation in connection loss, which makes the practical use difficult.

By using a plug connectable to the receptacle, the plug which has low loss despite being compact and which exhibits little variation in connection loss can be provided.

(15)

A connection method according to fifteenth aspect is the method for connecting the optical connector according to the first aspect to the twelfth aspects, the method including connecting the receptacle and the plug.

When magnetic force is used as the pressing force of the optical connector, a small difference in distance becomes a large difference in pressing force. When variation in contact force is generated on the end face of the optical connection, it leads to a large variation in connection loss, which makes the practical use difficult.

By using the method for connecting the optical connector, the connection method which has low loss despite being compact and which exhibits little variation in connection loss can be provided.

### BRIEF DESCRIPTION OF DRAWINGS

FIG. 1 is a schematic perspective view showing an optical connector of a first embodiment.

FIG. 2 is a partially exploded view to illustrate the structure of the optical connector of the first embodiment.

FIG. 3 is a schematic partial sectional view of the optical connector of the first embodiment.

FIG. 4 is a schematic perspective view showing a receptacle and a plug in the first embodiment.

FIG. 5 is a schematic explanatory view to illustrate the structure of the receptacle and the plug in the first embodiment.

FIG. 6 is a schematic explanatory view to illustrate a protection component in the first embodiment.

FIG. 7 is a schematic explanatory view to illustrate a boot in the first embodiment.

FIG. 8 is a schematic partial sectional view of an optical connector of a second embodiment.

FIG. 9 is a schematic perspective view showing a receptacle and a plug in the second embodiment.

FIG. 10 is a schematic explanatory view to illustrate the structure of connection surfaces of the receptacle and the plug in the second embodiment.

FIG. 11 is a schematic explanatory view to illustrate plate-shaped ferrules in the second embodiment.

FIG. 12 is a schematic sectional view showing an optical connector of a third embodiment.

FIG. 13 is a schematic perspective view showing an optical connector of a fourth embodiment.

FIG. 14 is a schematic perspective view showing another example of the optical connector of the fourth embodiment.

FIG. 15 is a schematic explanatory view to illustrate a modification of the first embodiment.

### DESCRIPTION OF EMBODIMENTS

Hereinafter, embodiments of the present invention will be described with reference to the drawings. While a plurality of embodiments are shown as the embodiments of the present invention, each of the embodiments may be carried out independently or one or more embodiments may be carried out in combination.

In the description below, identical components are denoted by identical signs. This also applies to the name and function of the identical components. Therefore, the detailed description of the identical components is not repeatedly provided.

### First Embodiment

### (Optical Connector 10)

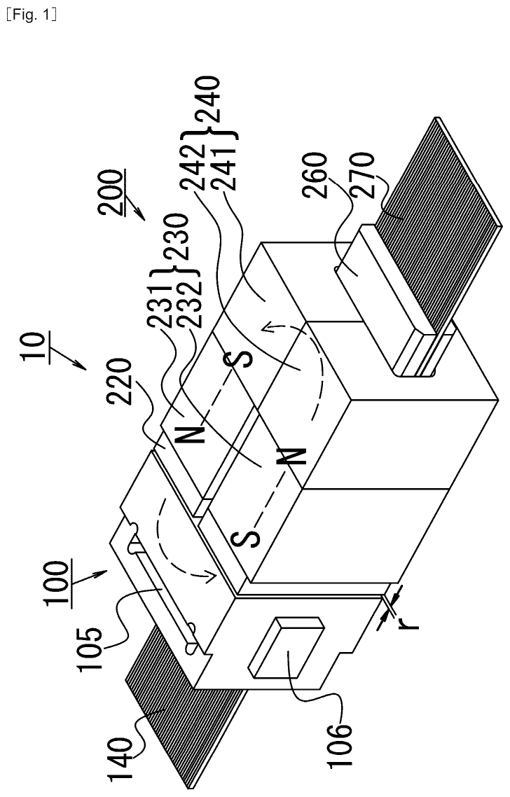

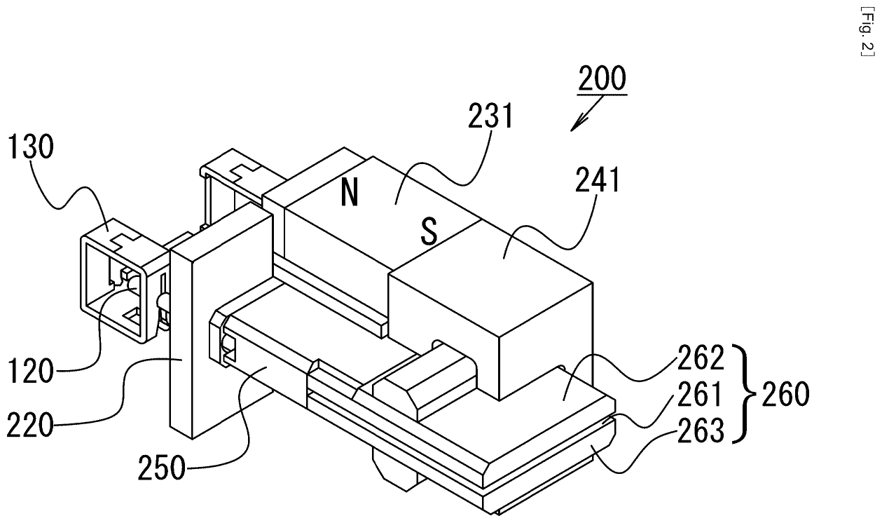

FIG. 1 is a schematic perspective view showing an optical connector 10 of a first embodiment, and FIG. 2 is a partially exploded view to illustrate the structure of the optical connector 10 of the first embodiment. The optical connector 10 of the present embodiment is configured so that a receptacle 100 and a plug 200 are connectable. The receptacle 100 and the plug 200 are each configured to introduce optical waveguide components, and when the receptacle 100 and the plug 200 are connected, the respective optical waveguide components can be optically connected.

In the optical connector 10 of the present embodiment, the plug 200 is provided with a magnet 230, and an attractive force acts between the receptacle 100 and the plug 200 due to the magnetic force of the magnet 230. As a result, a pressing force is applied to connection surfaces 104 and 225 of the receptacle 100 and the plug 200, so that the optical waveguide components can be connected to each other.

The optical waveguide components may be optical fibers, optical waveguides, optical communication elements, or the like. The optical fibers transmit optical signals by core-clad structure having different refractive indexes using fibrous quartz glass or the like. The optical waveguides form optical signal transmission paths on an electronic substrate or the like by semiconductor processing technology. The optical communication elements are light emitting elements, light receiving elements, light modulators or part thereof.

In the present embodiment, examples are shown in which optical fibers 140 and 270 are used as the optical waveguide components.

As shown in FIGS. 1 and 2, the optical connector 10 of the present embodiment is configured so that the receptacle 100 and the plug 200 are connectable. Note that FIG. 2 is a schematic perspective view showing the optical connector 10 of the present embodiment, with a receptacle 100, a second magnet 232, and a second yoke 242 being excluded.

The receptacle 100 in the present embodiment is provided with a plate-shaped ferrule 110, which is connected to the optical fiber 140, on the side of the connection surface, and is also provided with a guide pin 120 which determines the connection position of the plate-shaped ferrule 110 and the plate-shaped ferrule 210, and a pin keeper 130 which retains the guide pin 120.

The plug 200 in the present embodiment is provided with the plate-shaped ferrule 210, which is connected to the optical fiber 270, on the connection surface 225, and is also provided with a connection plate 220 having a recess portion 222, the magnet 230 arranged adjacent to the rear surface of the connection plate 220 (the side facing the connection surface 225), and a yoke 240 arranged behind the magnet 230 (the side opposite to the connection plate 220). The plug 200 in the present embodiment is also provided with a protection component 250, which is adjacent to the connection plate 220 and which allows insertion of the optical fiber 270 inside, and a boot 260 which retains the optical waveguide component extending from the plate-shaped ferrule 210 in parallel.

The present embodiment adopts a float structure in which the connection plate 220 and the plate-shaped ferrule 210 are fitted and fixed with the receptacle 100 and the plate-shaped ferrule 110 via the recess portions 222 and 102. As a result, the resistance to external force received at the time of connecting the optical connector 10 or other occasions is increased, and the accuracy of the separation distance r can be improved.

As shown in FIG. 1, the magnet 230 in the present embodiment is constituted of a first magnet 231 and the second magnet 232, which are arranged so that their polarity is opposite to each other. In addition, the connection plate 220, the receptacle 100, and the yoke 240 in the present embodiment are formed of magnetic bodies.

Therefore, as illustrated in FIG. 1, in the receptacle 100 in the present embodiment, the magnetic force generated from the N pole of the first magnet 231 reaches the receptacle 100 via the connection plate 220. The magnetic force also reaches from the receptacle 100 to the S pole of the second magnet 232 via the connection plate 220. In addition, the magnetic force generated from the N pole of the second magnet 232 reaches the S pole of the first magnet 231 via the yoke 240.

In other words, when the plug 200 is connected to the receptacle 100, a closed magnetic circuit is formed, so that the receptacle 100 and the plug 200 are strongly attracted to each other, which makes it possible to apply a strong contact force to the connection end face. Therefore, it is possible to provide the optical connector 10 which has low loss despite being compact.

### (Receptacle 100)

The receptacle 100 in the present embodiment has the recess portion 102, in which the plate-shaped ferrule 110 is fittable, on the connection surface 104, and a hole portion 103 into which the optical fiber 140 can be inserted. In addition, since the receptacle 100 in the present embodiment is made of a magnetic material, an attraction force acts with the magnet 230, so that a pressing force between the receptacle 100 and the plug 200 can be obtained.

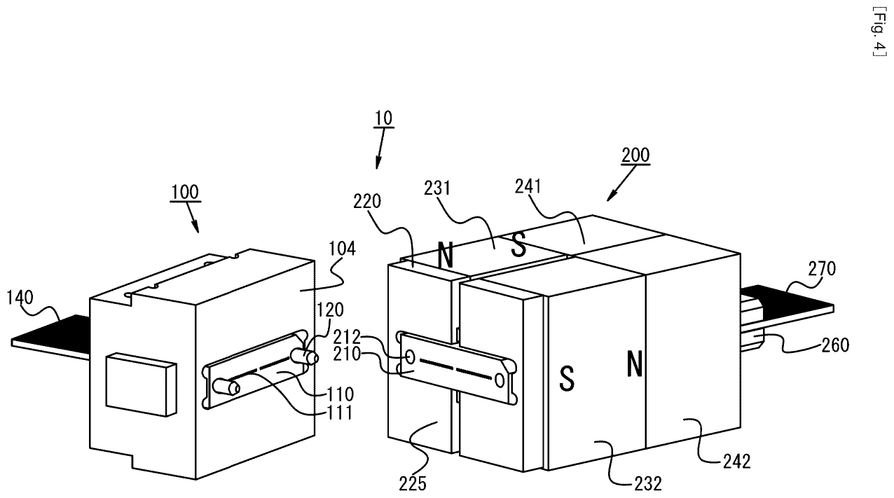

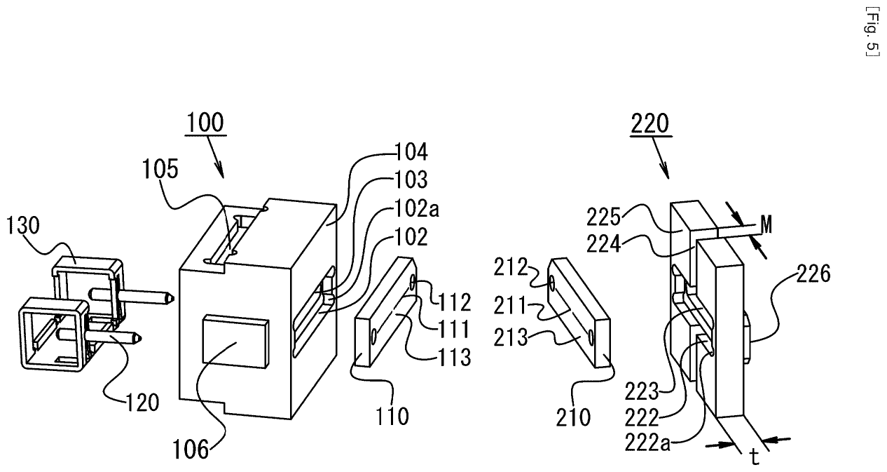

FIG. 4 is a schematic perspective view showing the receptacle 100 and the plug 200 in the present embodiment. FIG. 5 is a schematic explanatory view to illustrate the structure of the receptacle 100 and the plug 200 in the present embodiment, for showing exploded components of the receptacle 100.

As shown in FIGS. 4 and 5, the pin keeper 130 is contained in the receptacle 100, and the pin keeper 130 holds two guide pins 120. The receptacle 100 in the present embodiment is provided with an insertion hole on the surface, into which the optical fiber 140 is inserted (the surface opposite to a connection surface 104), to allow the pin keeper 130 to be inserted and removed to/from the receptacle 100 (not shown).

In the receptacle 100 in the present embodiment, the two guide pins 120 protrude from the connection surface 104, and thereby the plate-shaped ferrule 110 of the receptacle 100 and the plate-shaped ferrule 210 of the plug 200 are precisely positioned and optically connected.

On the connection surface 104 of the receptacle 100, the recess portion 102 is formed for fitting the plate-shaped ferrule 110, and the hole portion 103 is formed at the bottom surface of the recess portion 102. The recess portion 102 is formed in the center of the connection surface 104 of the receptacle 100, and the connection surface 104 of the receptacle 100 is formed in parallel to the bottom surface of the recess portion 102. As a result, the bottom surface of the recess portion 102 can perpendicularly apply a uniform pressing force to the plate-shaped ferrule 110. Moreover, an equal contact force can be applied to each fiber of the optical fiber 140 in the direction of the optical fiber 140, so that low loss and variation in connection loss can be minimized.

Since the plate-shaped ferrules 110 and 210 in the present embodiment receive the pressing force from the rear side in particular, the influence of the tolerance can be reduced while the ferrules is made compact as compared with the case of using typical MT ferrules for the connection surfaces 104 and 225. In addition, the number of required components can be reduced as compared with the case of using the typical MT ferrules, so that excellent manufacturability and assemblability are achieved. Since the number of components can be made smaller and the tolerance management surfaces can be made fewer, precise separation distance r is more easily achieved. Particularly, the thickness of the plate-shaped ferrules 110 and 210 can be adjusted by polishing or other processing, and the depth of the recess portion 222 in the connection plate 220 can be adjusted, so that precise control of the separation distance r can be performed, and the pressing force can be applied in parallel with the plate-shaped ferrules 110 and 210.

In addition, stronger magnetic force can be obtained by designing the thickness of the connection plate 220 to be thinner.

The receptacle 100 in the present embodiment has a shape in which the connection surface side protrudes in up-down directions (in top and bottom surface directions).

Moreover, fitting portions 105 are provided on the top surface and the bottom surface, and guide portions 106 protruding in a projecting shape are provided on both left and right side surfaces. The fitting portions 105 can be used as fixing means when the receptacle 100 is mounted on the substrate. The guide portions 106 can be used as a guide for jigs or the like when the plug 200 is connected to the receptacle 100.

The depth of the recess portion 102 is preferably equal to or less than the thickness of the plate-shaped ferrule 110, more preferably 0.1 mm or more to 1.5 mm or less, and is even more preferably designed so that a prescribed gap (separation distance r) can be formed as described below.

The bottom surface of the recess portion 102 is preferably subjected to precise processing, preferably formed with a processing precision of Ra 25.0 or less, and is more preferably formed with a processing precision of Ra 6.3 or less. As such a processing method, a cutting method using an end mill can be used. At the four corners of an elongated rectangular recess portion 102, relief portions 102a may be formed to release a cutting tool. In this case, the relief portions 102a formed at the four corners may be formed so as to protrude in the longitudinal direction of the plate-shaped ferrule 110. As a result, the processing precision of the bottom surface of the recess portion 102 can be enhanced, while high pressing force can be obtained by minimizing the blocking of the magnetic force.

On the bottom surface of the recess portion 102, the hole portion 103 is formed for the insertion of the guide pins 120 and the optical fiber 140. The optical fiber 140 extends from the connection end face of the plate-shaped ferrule 110 into the receptacle 100, passes through the hole portion 103 and the pin keeper 130, and extends outward through the insertion hole of the receptacle 100.

The surface of the plate-shaped ferrule 110 (the rear side opposite to the connection end face) from which the optical fiber 140 extends may have an adhesive applied and bonded to ensure that the plate-shaped ferrule 110 and the optical fiber 140 are fixed to each other. When such an adhesive pool exists, the presence of the hole portion 103 allows the bottom surface of the recess portion 102 and the rear side of the plate-shaped ferrule 110 to be in tight contact with each other.

The receptacle 100 in the present embodiment is formed of a magnetic body and is preferably a ferromagnetic body. As the materials for the magnetic body, soft magnetic materials or hard magnetic materials can be used. As examples of the soft magnetic materials, there may be adopted iron, silicon iron, permalloy, soft ferrite, sendust, permendur, and electromagnetic stainless steel. As examples of the electromagnetic stainless steel, there may be adopted ferritic stainless steel, martensitic stainless steel, and precipitation hardening stainless steel. As examples of the hard magnetic materials, there may be adopted ferrite magnets, alnico magnets, and rare earth magnets. As examples of the rare earth magnets, there may be adopted samarium-cobalt magnets, neodymium magnets, praseodymium magnets, and samarium iron-nitrogen magnets.

Since the receptacle 100 in the present embodiment has a structure integrated with an optical module, the receptacle 100 may be subjected to a heating process during mounting on a substrate, and therefore SUS430, which is a soft magnetic material with excellent heat resistance, is preferably used.

SUS430 is a stainless steel alloy containing 16% or more chromium by weight, and has a low volume expansion rate and excellent cutting processability. Therefore, precise cutting processing of the recess portion 102 or the like can be performed.

SUS630, which is a martensitic precipitation hardening stainless steel, is also one of the preferable materials. SUS630 is a stainless steel alloy containing copper, which may gain high strength and hardness and resistance to distortion by solid solution heat treatment. Metal injection molding (MIM) also enables mass production of complicated shape objects with high precision.

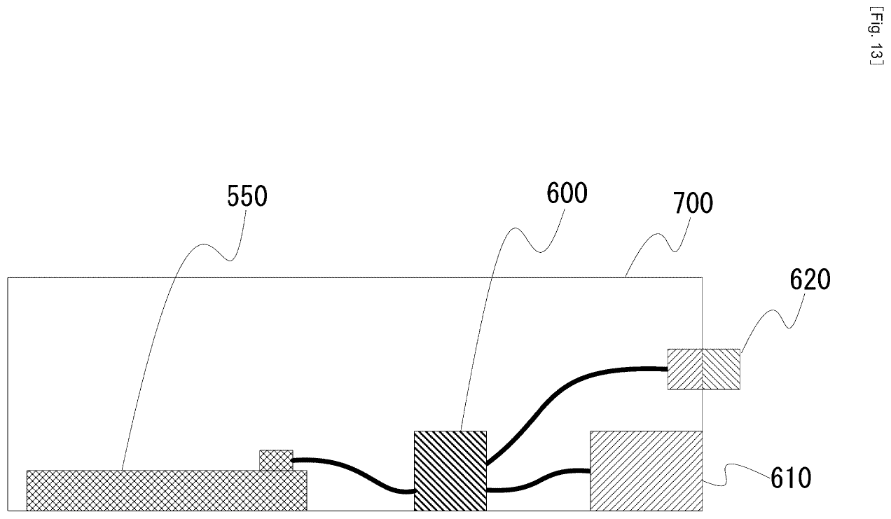

Note that, in the present embodiment, soft magnetic materials are used for the receptacle 100, though hard magnetic materials may be adopted as shown in FIG. 13. In this case, the attraction force formed with the magnet 230 on the plug 200 side can be strengthened. In addition, since the plug 200 is attracted according to the polarity which appears on the connection surface 104 of the receptacle 100, the connection direction (the upper and lower directions) of the plug 200 can be fixed to one direction.

### (Plate-Shaped Ferrules 110 and 210)

As shown in FIG. 5, the plate-shaped ferrules 110 and 210 in the present embodiment are formed from ceramic plates and have insertion holes 111 and 211 in which the optical waveguide components are mounted, and guide holes 112 and 212 into which the guide pins are inserted.

The use of ceramics as the material for the plates eliminates the need for conventional resin molding which uses molds, and machining of ceramics with high mechanical strength and heat resistance enables the formation of complex and precise shapes with high precision. By using machinable ceramics with excellent free-cutting performance in particular, excellent mass productivity and low cost can be achieved despite of machining. Furthermore, it also becomes possible to form two-dimensional arrayed holes, holes at smaller intervals, and the like, which were difficult with conventional resin-molding ferrules. Therefore, the number of the optical fibers 140 and 270 can be made larger than before for high-density optical connection, so that high-speed and large-capacity communications can be connected.

Note that the plate-shaped ferrule 110 and the plate-shaped ferrule 210 may be ferrules of the same configuration or may be ferrules of different configurations.

In the plate-shaped ferrules 110 and 210 used in the present embodiment, machinable ceramics are adopted as ceramics. Using the machinable ceramics makes it possible to perform fine and precise processing with low hardness at low cost.

For the plate-shaped ferrules 110 and 210, a surface identification structure may be formed. As an example of the surface identification structure, the plate-shaped ferrules 110 and 210 in the present embodiment have a notch formed at one corner of the rectangular plate body.

The plate-shaped ferrules 110 and 210 in the present embodiment are formed into a rectangular shape, with their connection end faces being formed in a rectangular shape. The dimensions of the plate-shaped ferrules 110 and 210 in the present embodiment may be 5 mm or more to 8 mm or less in lateral width, 1.5 mm or more to 4 mm or less in longitudinal width, and 0.4 mm or more to 2.5 mm or less in thickness. This makes it possible to miniaturize the plate-shaped ferrules 110 and 210 and obtain sufficient pressing force while achieving high-density optical communication.

The plate-shaped ferrules 110 and 210 in the present embodiment have the connection end faces which are vertically polished, though the plate-shaped ferrules 110 and 210 having the connection end faces diagonally polished may also be used. The influence of Fresnel reflection on the connection end faces can be prevented by diagonally polishing the connection end faces at an 8-degree angle, for example.

The optical fibers 140 and 270 are bonded to the insertion holes 111 and 211 of the plate-shaped ferrules 110 and 210 with adhesive. As usable adhesives, adhesive with excellent heat resistance such as ultraviolet light-curable adhesive, thermosetting adhesive, and two-liquid reactive adhesives can be used as appropriate.

The formation positions of the insertion holes 111 and 211 of the plate-shaped ferrules 110 and 210 are not particularly limited, and may be formed in a single row or in two or more rows. The positions of the insertion holes 111 and 211 may be appropriately designed depending on the communication direction.

The insertion holes 111 and 211 in the present embodiment are penetrated in the thickness direction of the plate bodies, with the plurality of insertion holes 111 and 211 being arranged in a row along the longitudinal direction of the rectangular plate body. Providing the insertion holes 111 and 211 in a row makes it easy to connect optoelectronic components or optical waveguides on a substrate 550 to the optical fibers 140 and 270 at the time of mounting on the substrate 550.

The plate-shaped ferrules 110 and 210 illustrated in the present embodiment (FIG. 5) are provided with two guide holes 212 and 112. While the design of the guide holes 212 and 112 is not particularly limited, the inner diameter of the guide holes 212 and 112 may be set to 0.55 mm or more to 0.7 mm or less, and the pitch in this case may be set to 4.6 mm or more to 5.3 mm or less. As a result, compatibility with existing MT ferrules or MPO connectors is provided. The guide holes 212 and 112 in the present example are formed with an inner diameter of 0.55 mm and a pitch of 5.3 mm.

The plate-shaped ferrules 110 and 210 illustrated in the present embodiment are provided with the plurality of insertion holes 111 and 211, and the lower limit of the number of insertion holes 111 and 211 may be set to, for example, one or more and may be set to eight or more. The upper limit may be set to 80 or less and may be set to 72 or less. In this case, the insertion holes 111 and 211 may be provided in a plurality of rows on the plate-shaped ferrules 110 and 210.

When the insertion holes 111 and 211 are provided in a single row on the plate-shaped ferrules 110 and 210, the number of insertion holes 111 and 211 may be set to, for example, 1 or more to 36 or less, and in this case, a guide pin pitch may be set to 5.3 mm and a guide hole diameter φ to 0.55 mm.

The insertion holes 111 and 211 can be appropriately designed according to the cladding diameter of the optical fibers 140 and 270 to be introduced. For example, in the case of using the optical fibers 140 and 270 with a cladding diameter of 80 μm, the pitch of the insertion holes 111 and 211 is preferably 80 μm or more. In the case of using the optical fibers 140 and 270 with a cladding diameter of 125 μm, the pitch of the insertion holes 111 and 211 is preferably 125 μm or more. In the case of using the optical waveguides, the pitch of the insertion holes 1111 and 211 can be set to 30 μm or more.

The optical connector 10 in the present embodiment may be provided with a refractive index matching material between the plate-shaped ferrule 110 and the plate-shaped ferrule 210, in addition to the case where the cores in the optical fibers 140 and 270 are brought into physical contact.

When the index matching material matched with the core refractive indexes of the optical fibers 140 and 270 is provided on the connection end faces of the optical fibers 140 and 270, Fresnel reflection can be restrained at the connection end faces, and even when the cores are not in physical contact with each other, reflection can be restrained and stable connection characteristics can be achieved.

In addition to the method of using the index matching material, an anti-reflection film may be formed on the connection end faces.

In addition, it is also possible to adopt a lens-coupled connection method in which a beam magnifying lens or the like is attached to the connection end faces of the optical fibers 140 and 270 while the optical fibers 140 and 270 are spaced apart without direct contact with each other, and a space-coupled connection method in which space is present between the optical fiber end faces. In that case, spacers or the like may be provided as appropriate.

### (Plug 200)

FIG. 2 is a partially exploded view to illustrate the structure of the optical connector 10 of the first embodiment, with the receptacle main body, the second magnet 232, and the second yoke 242 being excluded from the optical connector 10. FIG. 5 is a schematic explanatory view to illustrate the structure of the receptacle 100 and the plug 200 in the present embodiment, for showing the exploded components of the connection plate 220.

The plug 200 in the present embodiment is provided with the connection plate 220 that is provided with the plate-shaped ferrule 210 on the connection surface 225 side, the magnet 230 on the rear surface side of the connection plate 220 (the surface side opposite to the connection surface 225), and the yoke 240. The plug 200 is also provided with the protection component 250 and the boot 260 as internal components, as shown in FIG. 2.

Note that, although the protection component 250 and the boot 260 are illustrated as separate components in the present embodiment, they may be an integrated component.

### (Connection Plate 220)

The connection plate 220 in the present embodiment is a flat plate-shaped cube which is formed of a magnetic body, with the plate-shaped ferrule 210 arranged on the connection surface side. The plate-shaped ferrule 210 is applied with the pressing force from the connection plate 220, and comes into contact with the plate-shaped ferrule 110 so that optical communication is connected.

The connection plate 220 in the present embodiment has the recess portion 222, in which the plate-shaped ferrule 210 is fittable, on the connection surface side, and a hole portion 223 into which the optical fiber 270 can be inserted. In the connection plate 220 in the present embodiment, slits 224 is formed between a contact portion of the first magnet 231 and a contact portion of the second magnet 232.

The connection plate 220 in the present embodiment is preferably a flat cube, with the connection surface 225 and the rear surface (the surface opposite to the connection surface 225) being formed in parallel, with a thickness t being uniform. This allows a uniform pressing force to be applied to the connection surface 225.

A lower limit of the thickness t of the connection plate 220 is preferably 0.3 mm or more, and more preferably 0.5 mm or more. The upper limit of the thickness t is preferably 5 mm or less, more preferably 2.0 mm or less, and further more preferably 1.5 mm or less. This allows the magnetic force of the magnet 230 to be transmitted to the receptacle 100, while preventing the formation of a shortcut circuit (a circuit in which magnetism is directly applied from the first magnet 231 to the second magnet 232), thus ensuring the formation of a magnetic circuit that is via the receptacle 100. In addition, the presence of the prescribed thickness t allows precise processing of the connection surface 225.

As for the size of the connection surface 225 of the connection plate 220, a lateral width is preferably 7 mm or more to 20 mm or less, and more preferably 7.0 mm or more to 10 mm or less, and a longitudinal width is preferably 2 mm or more to 7 mm or less, and more preferably 4.0 mm or more to 7.0 mm or less. When the connection surface 225 of the connection plate 220 has a prescribed size or area, a sufficient pressing force can be obtained, so that high-density optical connection can be achieved.

In addition, the area of the connection plate 220 with respect to the cross sectional area of the magnet 230 (the area of the surface in contact with the connection plate 220) may be the same or larger. In the case of making the area larger, the area is preferably equal to or less than three times larger. When the cross sectional area of the magnet 230 is larger, more magnetic force can be applied as the pressing force.

On the connection surface 225 of the connection plate 220, the recess portion 222 is formed for fitting the plate-shaped ferrule 210, and the hole portion 223 is formed at the bottom surface of the recess portion 222. The recess portion 222 is formed in the center of the connection surface 225, and the connection surface 225 is formed in parallel to the bottom surface of the recess portion 222. As a result, the bottom surface of the recess portion 222 can apply a perpendicular and uniform pressing force to the plate-shaped ferrule 210. Moreover, since an equal contact force can be applied to each fiber of the optical fiber 270 in the direction of the optical fiber 270, low loss and variation in connection loss can be minimized.

The depth of the recess portion 222 is preferably equal to or less than the thickness of the plate-shaped ferrule 210, more preferably 0.1 mm or more to 1.5 mm or less, and further more preferably designed so that a prescribed gap (separation distance r) can be formed as described later.

The bottom surface of the recess portion 222 is preferably subjected to precise processing, preferably formed with a processing precision of Ra 25.0 or less, and more preferably formed with a processing precision of Ra 6.3 or less. As such a processing method, a cutting method using an end mill can be used.

At the four corners of an elongated rectangular recess portion 222, relief portions 222a can be formed to release a cutting tool. In this case, the relief portions 222a formed at the four corners are preferably formed to protrude in the longitudinal direction of the plate-shaped ferrule 210. As a result, the processing precision of the bottom surface of the recess portion 222 can be enhanced, while high pressing force can be obtained by minimizing the blocking of the magnetic force.

On the bottom surface of the recess portion 222, the hole portion 223 is formed for the insertion of the optical fiber 270. The optical fiber 270 extends from the connection end face of the plate-shaped ferrule 210 into the plug 200, passes through the connection plate 220 and the protection component 250, and extends outward through the boot 260.

The surface of the plate-shaped ferrule 210 (the rear side opposite to the connection end face) from which the optical fiber 270 extends may have an adhesive applied and bonded to ensure that the plate-shaped ferrule 210 and the optical fiber 270 are fixed to each other. When such an adhesive pool exists, the presence of the hole portion 223 allows the bottom surface of the recess portion 222 and the rear surface of the plate-shaped ferrule 210 to be in tight contact with each other.

The connection plate 220 in the present embodiment is formed of a magnetic body and is preferably a ferromagnetic body. As the material of the magnetic body, soft magnetic materials or hard magnetic materials can be used, and examples of the soft and hard magnetic materials are similar to the examples of the receptacle 100.

For the connection plate 220 in the present embodiment, soft magnetic materials are preferably used, soft magnetic materials with a magnetic permeability u (ambient temperature) of 20 N/A² or more are preferable, and soft magnetic materials of 80 N/A² or more are more preferably used. This allows efficient formation of a magnetic circuit. Among the soft magnetic materials, electromagnetic stainless steel is preferably used in terms of processability, cost, magnetic force, and the like.

For the connection plate 220 in the present embodiment, ferritic stainless steel or martensitic precipitation hardening stainless steel is preferably used among the electromagnetic stainless steel, SUS430 is preferably used in the case of the ferritic stainless steel, and SUS630 is preferably used in the case of the martensitic precipitation hardening stainless steel.

SUS430 is a stainless steel alloy containing 16% or more chromium by weight, and has a low volume expansion rate and excellent cutting processability. Therefore, precise cutting processing of the recess portion 222 or the like can be performed.

SUS630 is a stainless steel alloy containing copper, which may have high strength and hardness and be resistant to distortion by solid solution heat treatment. Therefore, metal injection molding (MIM) enables mass production with high precision.

Note that the connection plate 220 is preferably made of the same material (material of magnetic properties) as the receptacle 100, though different materials may also be combined.

In the connection plate 220 in the embodiment, the slits 224 are formed from the center of the two facing sides of the connection surface 225 toward the hole portion 223. Across the slits 224, the magnetic poles of the magnet 230 arranged on the rear side are reversed. Therefore, the magnetic poles that appear on the connection end face of the connection plate 220 are reversed across the slits 224. Providing the slits 224 can prevent the formation of a shortcut of the magnetic circuit (for example, a circuit in which magnetism is directly applied from the first magnet 231 to the second magnet 232), thus ensuring the formation of a magnetic circuit via the receptacle 100.

In this case, the width of the slits 224 is preferably the same distance as a gap M between the first magnet 231 and the second magnet 232.

Note that, although the slits 224 in the present embodiment are formed so as to be perpendicular to the long side of the hole portion 223 as an example, the slits 224 may be formed so as to be perpendicular to the short side of the hole portion 223 depending on the size of the connection plate 220. The slits 224 in the present embodiment formed as two slits 224 from the two facing sides of the connection surface 225 are shown as an example, though the single slit 224 may be provided only in one of the two sides.

In addition, the connection plate 220 in the present embodiment is provided with a protruding portion 226 on the back surface. The protruding portion 226 is formed to incorporate the optical fiber 270 and is in the same shape as the outer form of the protection component 250.

As the connection plate 220 in the present embodiment is provided with the protruding portion 226, the connection plate 220, which is integrated with the protection component 250 at the time of assembling the plug 200, can position and fix the first magnet 231 and the second magnet 232.

### (Magnet 230)

In the plug 200, the magnet 230 is adjacently arranged on the back surface of the connection plate 220. The magnet 230 has an N pole and an S pole along the longitudinal direction of optical fiber 270, and is arranged so that an attractive force acts between the receptacle 100 and the magnet 230.

As shown in FIGS. 1 and 2, the magnet 230 in the present embodiment is constituted of the first magnet 231 and the second magnet 232, and the first magnet 231 and the second magnet 232 face each other along the longitudinal direction of the optical fiber 270 and have a U-shape to incorporate the protection component 250.

In this case, the gap M between the first magnet 231 and the second magnet 232 is preferably 0.1 mm or more to 2.0 mm or less, and more preferably 0.1 mm or more to 1.0 mm or less. This allows effective configuration of a magnetic circuit.

As the magnet 230 in the present embodiment, hard magnetic materials (permanent magnets) or electromagnets can be used. As the hard magnetic materials, there may be adopted, for example, ferrite magnets, alnico magnets, and rare earth magnets. As the rare earth magnets, there may be adopted, for example, samarium-cobalt magnets, neodymium magnets, praseodymium magnets, and samarium iron-nitrogen magnets. As the material for the magnet 230, rare earth magnets are preferably used. The rare earth magnets have high residual magnetic flux density and coercive force, so that a compact rare earth magnet can provide powerful pressing force.

The magnet 230 in the embodiment is preferably a samarium-cobalt magnet or a neodymium magnet among the rare earth magnets. Thus, strong magnetic force with reduced thermal demagnetization and high magnetic flux density can be obtained. Among the above two magnets, the neodymium magnet is more preferable. This makes it possible to provide the magnet 230 also with excellent impact resistance. Here, when the plug 200 is exposed to high temperatures, the neodymium magnet doped with dysprosium may be used as appropriate.

For the magnet 230 in the present embodiment, a residual magnetic flux density Br is preferably 12×10⁻¹ T or more, and more preferably 13×10⁻¹ T or more. For the magnet 230 in the present embodiment, a retention force Hcj is preferably 800 kA/m or more, and more preferably 950 A/m or more. As a result, it is possible to generate strong magnetic force with excellent heat resistance even in a flat shape, so that sufficient pressing force can be stably applied regardless of being compact.

Note that in the case of the magnet 230 shown in FIGS. 1 and 2, the first magnet 231 has the N pole on the connection surface side and the second magnet 232 has the S pole on the connection surface side, though the polarity may be reversed.

Although an example has shown in which the magnet 230 illustrated in the present embodiment is constituted of two magnets, the first magnet 231 and the second magnet 232, the magnet 230 is not limited to the example and may be constituted of four magnets. When the magnet 230 is constituted of four magnets, four polarities, S, N, S, and N poles appear on upper, lower, left, and right portions on the connection surface side. In this case, four slits 224 may be provided as necessary.

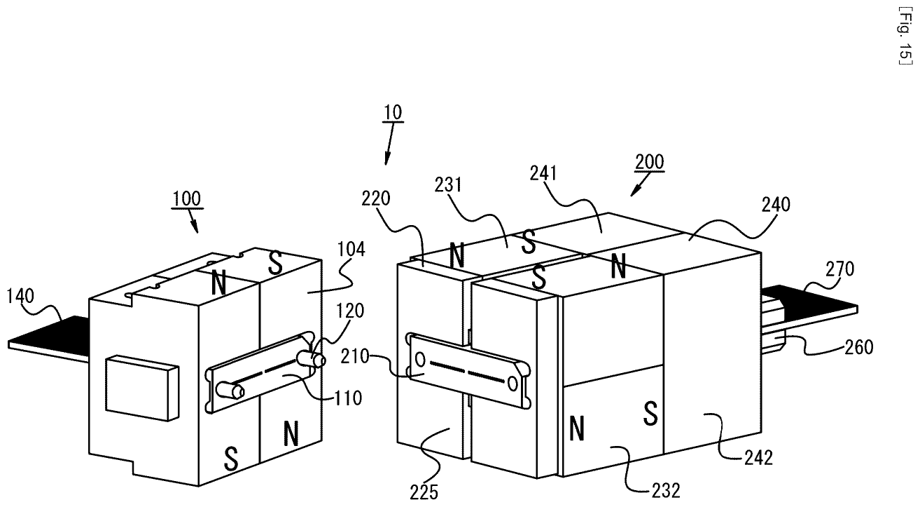

FIG. 15 is a schematic perspective view showing a modification of the optical connector 10 of the present embodiment. In this case, the receptacle 100 is provided with two magnets, and the magnets are arranged so as to be different in polarity from each other. In addition, the magnet 230 of the plug 200 is provided with four magnets, which are arranged so as to be different in polarity in the left and right directions as well in the upper and lower directions on the connection surface 225.

Arranging the magnets in this way can fix the connection direction (the upper and lower directions) of the plug 200 to one direction and can further increase the pressing force.

### (Yoke 240)

As shown in FIGS. 1 and 2, the plug 200 in the present embodiment is provided with the yoke 240 on the side of the magnet 230 opposite to the connection plate 220.

The yoke 240 in the present embodiment is formed of a magnetic body, which allows the first magnet 231 and the second magnet 232 to be magnetically coupled. Specifically, as shown in FIG. 1, the first magnet 231 and the second magnet 232 are arranged like bar magnets with their polarity being reversed in plan view. As the yoke 240 which is a magnetic body is arranged on the rear end face thereof, the first magnet 231, the yoke 240, and the second magnet 232 serve as a single U-shaped magnet. Thus, the yoke 240 allows the entire plug to behave like one large magnet.

As the material of the magnetic body of the yoke 240 in the present embodiment, soft magnetic materials or hard magnetic materials can be used, and examples of the soft and hard magnetic materials and the magnetic properties are similar to those in the example of the receptacle 100.

For the connection plate 220 in the present embodiment, SUS430 is adopted.

In addition, the yoke 240 in the present embodiment is constituted of two yokes, a first yoke 241 and a second yoke 242. The first yoke 241 and the second yoke 242 can be arranged in accordance with the arrangement of the first magnet 231 and the second magnet 232.

At the time of assembling the plug 200, the first yoke 241 is attached to the first magnet 231 and the second yoke 242 is attached to the second magnet 232, and then they are fixed to the protection component 250, which allows the first magnet 231 and the second magnet 232 to attract each other to ensure accurate arrangement of the two magnets.

### (Protection Component 250)

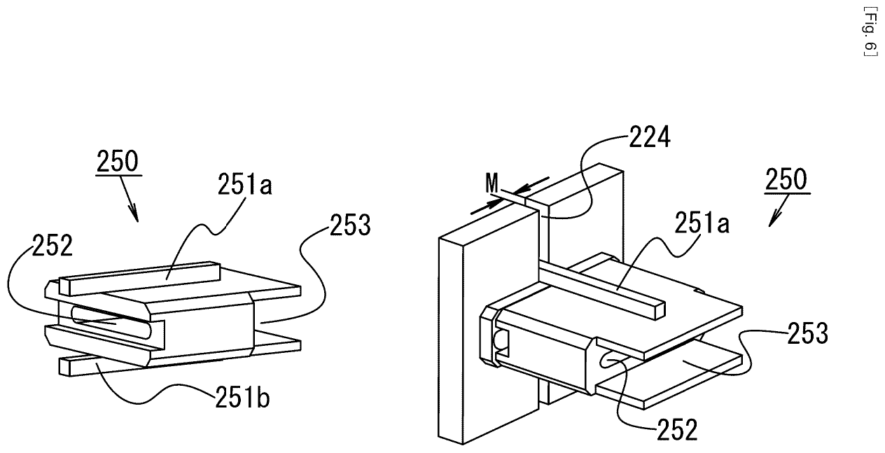

As shown in FIG. 2, the plug 200 in the present embodiment is adjacent to the connection plate 220 and is provided with the protection component 250 arranged inside the magnet 230. As shown in FIG. 6, the protection component 250 has an insertion hole 252 in which the optical fiber 270 can be inserted, and a boot insertion portion 253, in which the boot 260 can be fitted, on the side opposite to the connection plate 220.

The material of the protection component 250 is preferably formed of non-magnetic materials from the point of the ease of assembly. As the non-magnetic materials, there may be used copper, austenitic stainless steel, aluminum, plastic, or the like, and aluminum is preferably used in terms of processing precision and cost.

As shown in FIG. 6, the protection component 250 in the present embodiment has protruding portions 251a and 251b protruding in parallel to a longitudinal central axis of the optical waveguide component on the upper and lower surfaces.

As shown in FIGS. 1 and 2, since the first magnet 231 and the second magnet 232 are accurately arranged with the protruding portion 251a on the upper surface and the protruding portion 251b on the lower surface interposed therebetween, the gap M is provided between the first magnet 231 and the second magnet 232, which ensures the configuration of the magnetic circuit.

The protruding portions 251a and 251b are formed so as to extend from the end portion of the protection component 250 toward the connection plate 220 and are configured to be inserted into the slits 224 of the connection plate 220. This makes it possible to accurately determine the arrangement positions of the connection plate 220 and the protection component 250.

Moreover, in the protection component 250, the magnet 230 and the yoke 240 are accurately arranged. Therefore, the connection plate 220, the first magnet 231, and the second magnet 232 are accurately positioned via the protection component 250. As a result, the attraction force of the magnet 230 is perpendicularly transmitted to the entire surface of the connection plate 220, which makes it possible to provide the optical connector 10 which has low loss and which exhibits little variation in connection loss.

### (Boot 260)

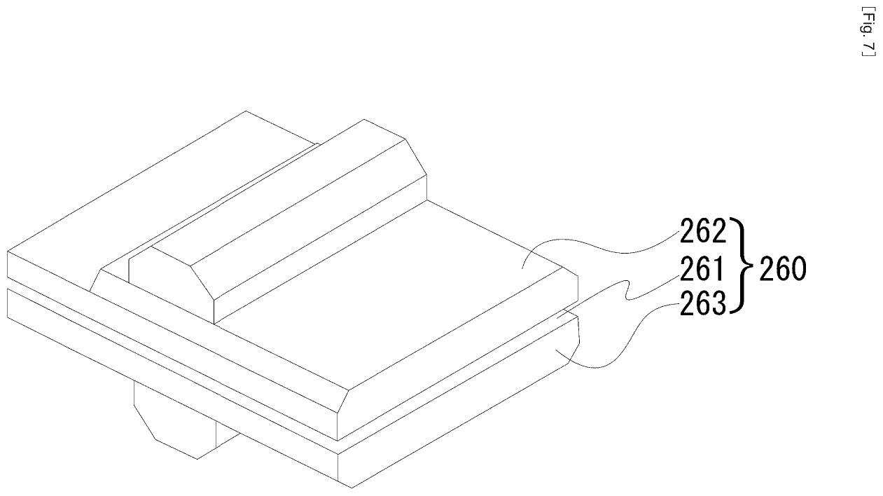

The plug 200 in the present embodiment is provided with the boot 260 so that the boot 260 is fit into the boot insertion portion 253 of the protection component 250. As shown in FIG. 7, the boot 260 is provided with a holding portion 261 which can hold the optical fiber 270 inserted therein.

In the present embodiment, fibers of the optical fiber 270 with their cladding exposed are mounted in the insertion hole 211 of the plate-shaped ferrule 210, and a fiber ribbon cable constituted of a plurality of fibers bundled with resin or the like is inserted and held in the holding portion 261 of the boot 260.

The holding portion 261, which is formed of an elastic body such as resin or rubber, has a gap of approximately the same size as the fiber ribbon cable of the optical fiber 270. Accordingly, as the fibers of the optical fiber 270 extending from the plate-shaped ferrule 210 are retained in parallel, it is possible to reduce the load on the optical fiber 270 and prevent breaking of the fibers.

The boot 260 in the present embodiment is also formed to extend from the rear end face of the plug 200 (the surface of the yoke 240 opposite to the magnet 230 side). This can protect the optical fiber 270 from bending.

The boot 260 can protect the optical fiber 270 extending from the rear end face of the plug 200 and can reduce the load generated at the edge of the yoke 240 in particular. In addition, the boot 260 can retain the optical fiber 270 inside the plug 200.

Moreover, by adopting materials such as resin or rubber for the boot 260, the friction can be increased to prevent the optical fiber 270 from slipping in the inside even when the plug 200 is held by hand. In addition, using materials with superior elasticity can reduce the stress applied to the optical fiber 270, and therefore the boot 260 is suitable in the case of adopting fibers with a smaller clad diameter to support higher density or adopting polarization maintaining fibers (PMF).

Since the boot 260 in the present embodiment is a vertically divided type constituted of boots 262 and 263, the plug 200 can be assembled using the optical fiber 270 which is connected to the plate-shaped ferrule 210. In addition, using the divided type boots 262 and 263 eliminates the need for inserting the optical fiber 270 to the boot 260, so that load is less likely to be applied and failure is less likely to occur even when the optical fiber 270 with a small clad diameter is used.

Note that in addition to the divided type boot 260, an integrated boot with a cavity provided inside to allow the optical fiber 270 to penetrate may be used, and the penetrating optical fibers 140 and 270 may be fixed to the boot 260 with adhesive.

### Second Embodiment

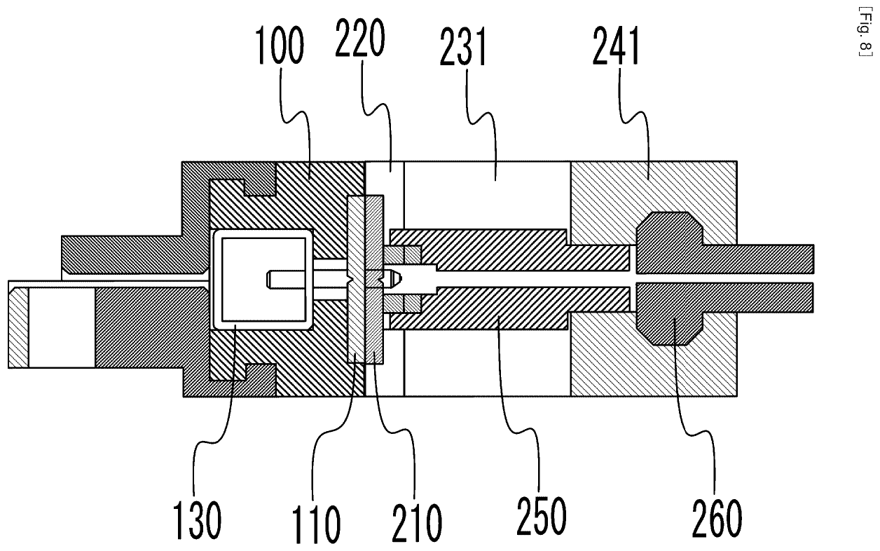

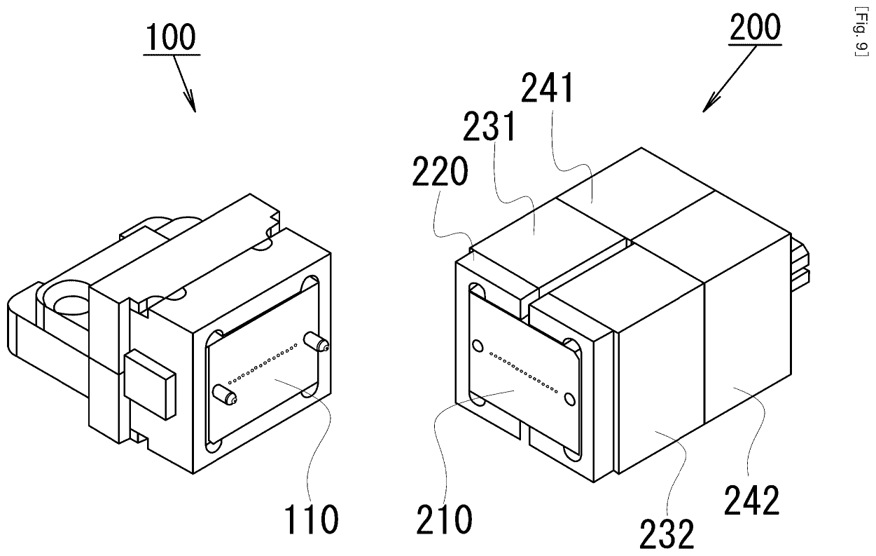

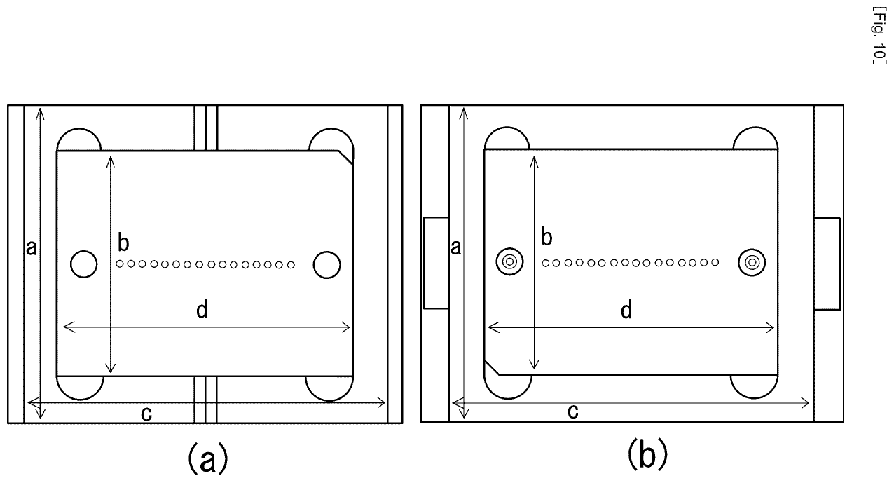

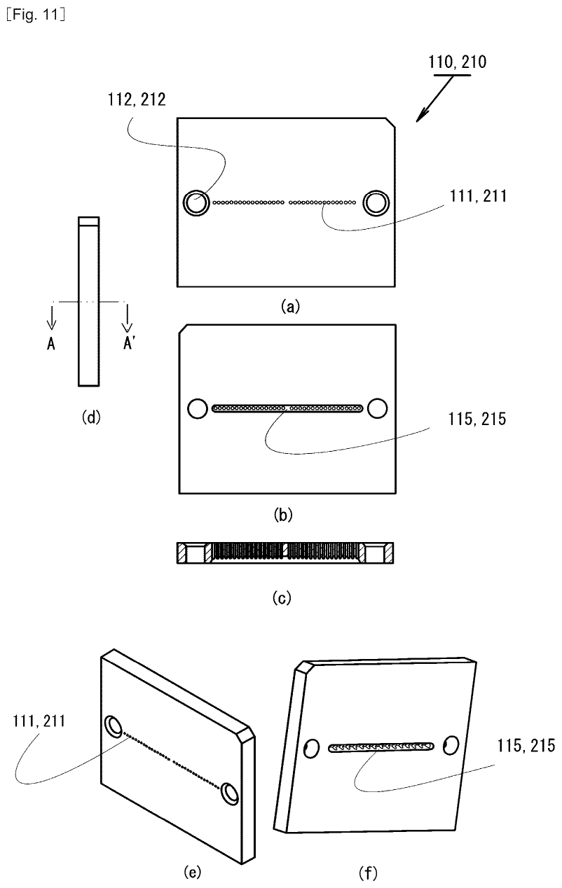

FIG. 8 is a schematic partial sectional view of the optical connector 10 of a second embodiment, and FIG. 9 is a schematic perspective view showing the receptacle 100 and the plug 200 in the second embodiment. FIG. 10 is a schematic explanatory view to illustrate the structure of the connection surfaces of the receptacle 100 and the plug 200 in the second embodiment. FIG. 11 is a schematic explanatory view to illustrate the plate-shaped ferrules 110 and 210 in the second embodiment, in which FIG. 11(a) is a front view, FIG. 11(b) is a rear view, FIG. 11(c) is a sectional view of FIG. 11(d) along an A-A′ line, FIG. 11(d) is a right side view, FIG. 11(e) is a perspective view showing front right upper sides, and FIG. 11(f) is a perspective view showing rear right upper sides.

Hereinafter, description is give of only the aspects of the optical connector 10 according to the second embodiment, which are different from those of the optical connector 10 according to the first embodiment.

As shown in FIGS. 10 and 11, the plate-shaped ferrules 110 and 210 in the present embodiment are formed into a rectangular shape, with their connection end faces being formed in an approximately square shape. As for the dimensions of the plate-shaped ferrules 110 and 210 in the present embodiment, a lateral width d is preferably 5.0 mm or more to 8.0 mm or less, and more preferably 6.0 mm or more to 7.0 mm or less. A longitudinal width b is preferably 3.5 mm or more to 7 mm or less, and more preferably 4 mm or more to 6 mm or less. A thickness is preferably 0.4 mm or more to 2.5 mm or less, and more preferably 0.6 mm or more to 1.3 mm or less.

In this case, the external dimensions of the connection surface 225 of the connection plate 220 and the connection surface 104 of the receptacle 100 are preferably equal to or more than the external dimensions of the plate-shaped ferrules 110 and 210. Specifically, a lateral width c is preferably 6 mm or more to 15 mm or less, and more preferably 7.0 mm or more to 9.0 mm or less. A longitudinal width a is preferably 4 mm or more to 10 mm or less, and more preferably 5.0 mm or more to 8.0 mm or less. The recess portions 102 and 222 of the connection plate 220 and the receptacle 100 are appropriately designed to be able to house the plate-shaped ferrules 110 and 210 in the present embodiment, and the depth of the recess portions 102 and 222 is preferably designed so that the gap (separation distance r) is 0.1 mm or more to 1.5 mm or less, more preferably designed so that the gap is 0.3 mm or more to 0.8 mm or less, and further more preferably designed so that the gap is 0.4 mm or more to 0.6 mm or less.

This makes it possible to miniaturize the plate-shaped ferrules 110 and 210 and obtain sufficient pressing force while achieving high-density optical communication.

As shown in FIG. 10, a longitudinal width b of the plate-shaped ferrules 110 and 210 is preferably the length of the side corresponding to 50% or more of the longitudinal width a of the connection surfaces 104 and 225 of the connection plate 220 and the receptacle 100, and is more preferably the length of the side corresponding to 60% or more. A lateral width d of the plate-shaped ferrules 110 and 210 is also preferably the length of the side corresponding to 50% or more of the lateral width c of the connection surfaces 104 and 225, and is more preferably the length of the side corresponding to 60% or more. In this case, the recess portion 222 of the connection plate 220, which houses the plate-shaped ferrules 110 and 210, is preferably arranged in a longitudinal and lateral center of the connection surface 225.

A ratio of the difference between the longitudinal width a and the longitudinal width b to the difference between the lateral width c and the lateral width d ((a−b)/(c−d)) is preferably 0.5 or more to 1.5 or less, and is more preferably 0.8 or more to 1.3 or less.

Moreover, the plate-shaped ferrule 110 of the receptacle 100 and the plate-shaped ferrule 210 of the plug 200 preferably have the same external dimensions.

As a result, an exposed portion of the connection surface 225 of the connection plate 220 which forms a magnetic circuit is equalized within a prescribed range in the longitudinal and lateral directions across the plate-shaped ferrules 110 and 210, and therefore the plate-shaped ferrules 110 and 210 can be stably connected to each other.

As shown in FIG. 11, on the rear side (the side opposite to the connection surface) of the plate-shaped ferrules 110 and 210 in the second embodiment, guiding tapers 115 and 215 are provided for the insertion holes 111 and 211 for the optical fiber. The tapers 115 and 215 preferably have an angle of 20 degrees or more to 100 degrees or less, and a depth of 0.1 mm or more to 0.5 mm or less. The thickness of the plate-shaped ferrules 110 and 210 is preferably made thicker for the provided tapers 115 and 215.

In the example shown in FIG. 11, the tapers 115 and 215 with an angle of 50 degrees are provided at a depth of 0.2 mm, and the thickness of the plate-shaped ferrules 110 and 210 is set to 0.6 mm.

As a result, it is easier to insert optical fibers into the insertion holes 111 and 211 even in the case of using optical fibers with a smaller cladding diameter such as 50 μm or 80 μm. It is also possible to fill the tapers 115 and 215 with adhesive to fix the primary coating of the optical fibers with the adhesive on the taper side. This makes it possible to reduce the load on the optical fibers.

By increasing the thickness of the plate-shaped ferrules 110 and 210 in accordance with the depth of the tapers 115 and 215, crack and breakage can be prevented at the time of connecting the optical connector.

Furthermore, in the example of FIG. 11, the guide holes 112 and 212 for guide pin insertion are also tapered on the front side (connection surface side) of the plate-shaped ferrules 110 and 210. This allows smooth insertion of the guide pins during connection.

While the preferable thickness value of the plate-shaped ferrules 110 and 210 is as described above, the thickness of the plate-shaped ferrules 110 and 210 is preferably 9 times or more to 11 times or less of the cladding diameter of the optical fibers inserted into the insertion holes 111 and 211.

Specifically, in the case of optical fibers with a cladding diameter of 80 μm, the thickness of the plate-shaped ferrules 110 and 210 is preferably set to 0.7 mm or more to 0.9 mm or less, and in the case of optical fibers with a cladding diameter of 125 μm, the thickness of the plate-shaped ferrules 110 and 210 is preferably set to 1.1 mm or more to 2.4 mm or less.

As a result, the processing precision of the insertion holes 111 and 211 can be secured, so that the optical connector 10 which has minimum connection loss can be provided.

### Optical Module: Third Embodiment

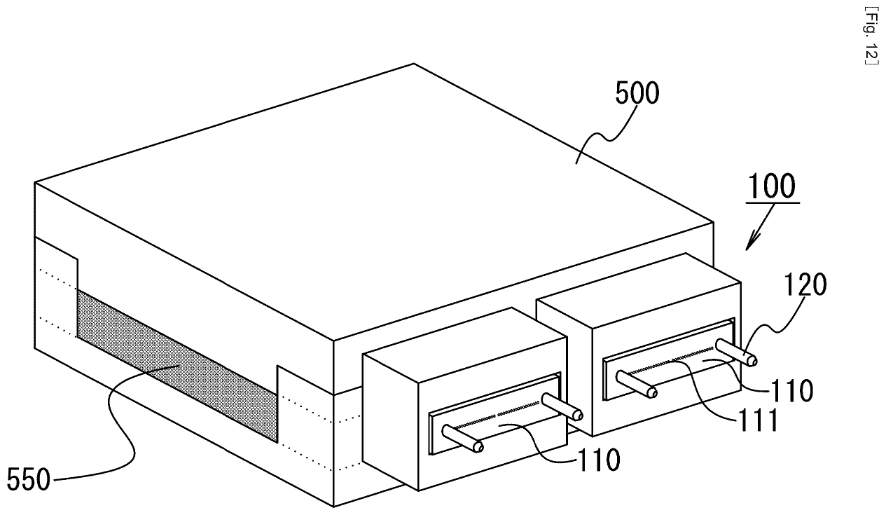

As shown in FIG. 12, the optical connector 10 in the first or second embodiment (simply referred to as the embodiment) can be mounted on the substrate 550 that is an electronic component and modularized. This makes it possible to perform high-speed and large-capacity information processing. FIG. 12 is an example of an optical module 500 formed by mounting the receptacle 100 in the embodiment on the substrate 550.

The optical connector 10 of the embodiment may be configured so that the receptacle 100 side is connected to the substrate 550 and the plug 200 side is connected to another circuit board via the optical fiber 270.

In addition to various electronic components, optical communication elements, such as light emitting elements, light receiving elements, or optical modulators, can be mounted on the substrate 550. To the receptacle 100, an optical signal can be connected from these optical communication elements via an optical fiber 140 or via an optical waveguide or the like.

Note that the substrate mounting method illustrated above is exemplary, and the plate-shaped ferrules 110 and 210 of the optical connector 10 can be connected to various optical waveguide components, such as glass optical waveguides, polymer optical waveguides, and film optical waveguides, in addition to the optical fibers 140 and 270. In addition, an optical communication element with the function of the receptacle 100 may be prepared, and the optical communication element may be directly connected to the plug 200 without using the receptacle 100 in the embodiment.

The plate-shaped ferrule 110 (and the plate-shaped ferrule 210 connected thereto) shown in FIG. 12 may have the insertion holes 111 and 211 formed in a row corresponding to an optical fiber for transmission and an optical fiber for reception for the optical module. Providing the insertion holes 111 and 211 in a row makes it easy to connect optoelectronic components or optical waveguides on the substrate 550 to the optical fibers 140 and 270.

The plate-shaped ferrules 110 and 210 in the embodiment can also support the optical module configuration using an external light source (ELS). In this case, the position of the insertion holes 111 and 211 for the external light source can be appropriately designed in the plate-shaped ferrules 110 and 210. For example, the insertion holes 111 and 211 of a single row are modified so that only the center pitch is doubled, so that high-energy CW light from an external light source ELS can be introduced into the two optical fibers 140 and 270 located at the center. Optical communication is carried out by the outer 16cH×right and left two optical fibers 140 and 270.

In this case, the optical fibers 140 and 270 which transmit the external light source ELS are preferably polarization maintaining fibers. This can restrain loss and delay of high-power light from the external light source. In addition, since linearly polarized light from the external light source can be maintained, semiconductor modulators (such as Mach-Zehnder interference modulators and electric field absorbing type modulators) can be used on the substrate 550 side. Note that the optical fibers 140 and 270 may all be the polarization maintaining fibers, or some of the fibers, such as those for external light source transmission, can be the polarization maintaining fibers.

The optical connector 10 mounted on the substrate 550 can be the optical connector 10 of multiple constitution as described later.

### Midboard Connector; Fourth Embodiment

The optical connector 10 of the first or second embodiment can also be used as an optical connection component of a midboard connector 600. As illustrated in FIG. 13, the midboard connector 600 is a relay connector installed between the substrate 550 mounted with an optical engine and another optical device 610, such as an external light source, or a casing connection unit 620 for connection to an external computer or the like.

By using the midboard connector 600, optical wiring in a casing 700 can be intensively arranged to prevent complicated wiring and the wiring length can be shortened to reduce the risk of damaging the wiring.

Note that the optical connector 10 mounted on the substrate 550 can be the optical connector 10 of multiple constitution as described later.

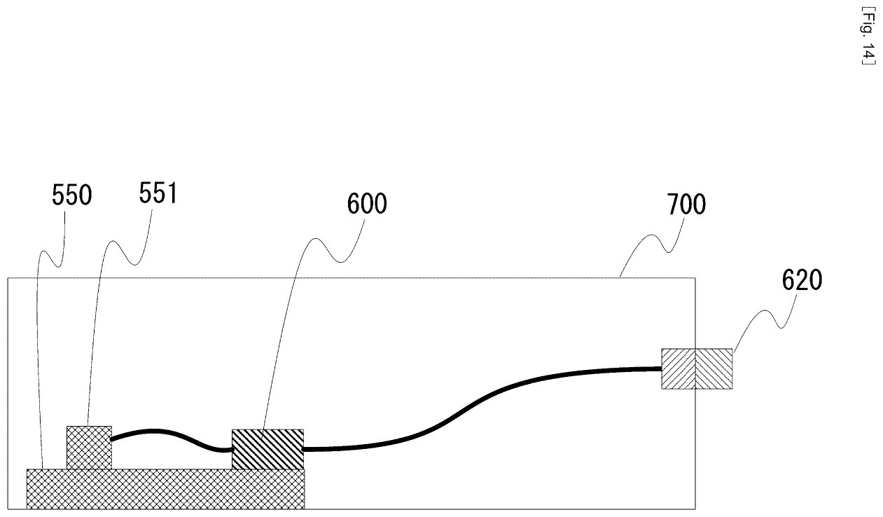

FIG. 14 illustrates another example of the fourth embodiment, which is an example of another use mode of the midboard connector 600.

In this case, the substrate 550 can be a printed circuit board (PCB) with host functions, and the substrate 550 is mounted with a photonic integrated circuit (PIC) 551 and/or the midboard connector 600. The photonic integrated circuit 551 is provided with two or more optical components integrated on the same substrate, and examples of the photonic integrated circuit 551 may include an integration of a laser, an element such as light receiving elements, and a functional element such as splitters, combiners, couplers, interferometers, modulators, filters, isolators, and delay lines.

An optical wiring from the midboard connector 600 may be connected to the casing connection unit 620 for connection to an external computer or to another substrate 550. The substrate 550 may be provided with a single midboard connector 600 or be provided with a plurality of the midboard connectors 600 as multiple constitution.

This allows an electrically processed signal to be optically connected to another substrate 550 or another computer.

The illustration is exemplary, and the midboard connector 600 can also be used in other modes, such as a PIC-to-PIC connection within the board.

### Multiple Constitution: Fifth Embodiment

FIG. 12 is a schematic explanatory view showing an example of the optical connector 10 mounted on the optical module 500. The optical module 500 has the substrate 550 arranged inside a chassis. The substrate 550 is mounted with optical devices such as an optical modulator, a light source, and a light receiving element, and is connected to the receptacle 100 through an optical fiber.

Furthermore, as shown in FIG. 12, the optical module 500 may be mounted with a plurality of receptacles 100 (modification of the third embodiment). Fan-out can be facilitated by connecting the plug 200 to each of the receptacles 100.

The optical connector 10 may also be appropriately provided with connection components or removal components depending on the application or location for installation.

For example, in a narrow and overcrowded server wiring connection surface, a guide component for inserting the plug 200 may be provided so that the optical connector 10 is smoothly detachable. Similarly, a detachable tool for removing the plug 200 may be provided separately. For example, the guide portions 106 shown in FIGS. 1 and 5 are protrusions to facilitate detachment of the plug.

The optical connector 10 in the embodiment has an internally closed magnetic circuit, which is formed using a strong rare earth magnet. Accordingly, when components made of magnetic bodies, such as metal screws, are present in the vicinity of the optical connector 10, there is a possibility of attraction. In the state before the plug 200 and the receptacle 100 are connected in particular, there is a possibility that components made of magnetic bodies are strongly attracted.

In such cases, it can be considered that the components or the optical connector 10 are damaged and cleaning becomes difficult when the magnetic body is powder, and therefore the plug 200 may be covered with a protective film or a protective case. As an example of the protective case, a silicone resin case may be used as appropriate, for example.

### [Contact Force Analysis]

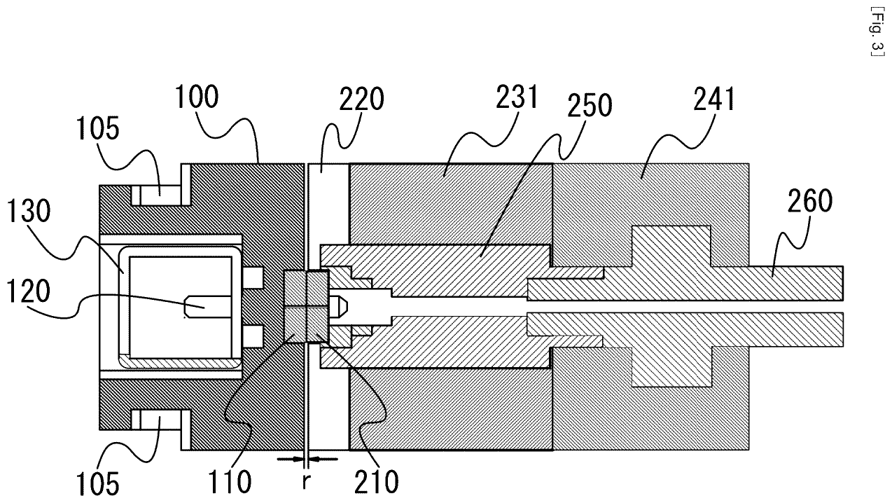

FIG. 3 is a schematic partial sectional view to illustrate an optical connection portion of the optical connector 10 in the embodiment.

In the optical connector 10 of the embodiment, the separation distance r between the connection surface 104 of the receptacle 100 and the connection surface 225 of the plug 200 is determined based on the relationship between the thickness of the recess portion 102 of the receptacle 100 and the plate-shaped ferrule 110 and the thickness of the recess portion 222 of the connection plate 220 and the plate-shaped ferrule 210.

A lower limit of the separation distance r is preferably 0.02 or more and more preferably 0.05 mm or more. An upper limit of the separation distance r is preferably 0.5 mm or less, more preferably 0.3 mm or less, more preferably 0.26 mm or less, and further more preferably 0.22 mm or less.

### EXAMPLES

The connection plate 220 of a first example was fabricated with SUS430 to have the shape of 8.0 mm wide×7.0 mm high×1.0 mm thick (connection area of 44 m²), with the width M of the slits 224 being 0.5 mm. The depth of the recess portion 222 of the connection plate 220 was set to 0.42 mm.

The receptacle 100 was fabricated with SUS630, the connection surface 225 was made into the shape of 8.0 mm wide×7.0 mm high×5.0 mm deep (connection area of 44 m²), with the recess portion 102 having a depth of 0.42 mm.

The plate-shaped ferrules 110 and 210 of the first example were fabricated with machinable ceramics to have 6.4 mm wide×1.7 mm high×0.5 mm thick.

The first magnet 231 and the second magnet 232 in this example were fabricated with neodymium magnets (residual magnetic flux density 1.33 to 1.36 T, retention force 955 kA/m or more), the shape of one side being 4.05 mm wide×7.0 mm high×5.0 mm deep (sectional area of 23 mm²), and the gap M between the first magnet 231 and the second magnet 232 was 0.5 mm.

As a result of designing as described above, it was confirmed that a contact force of 10 N could be obtained between the plate-shaped ferrule 110 and 210.

This strong contact force is achieved by the formation of a closed magnetic circuit between the receptacle 100 and the plug 200. Therefore, it was confirmed that the formation of the magnetic circuit had a significant influence on the contact force.

It was found out that when the separation distance r was set to 0.01 mm by changing the depth of the recess portions 102 and 222 and/or changing the thickness of the plate-shaped ferrules 110 and 210, the contact force was 25 N, and when the separation distance r was set to 0.3 mm, the contact force was 8 N.

As a result, it was confirmed that the contact force was controllable and that the contact force of 10 N or 20 N, which was required for typical MPO connectors, was achieved by the compact optical connector 10.

Next, as a result of confirming the leakage of the magnetic force of the optical connector 10 of the present example, it was confirmed that the influence of the magnetic force was almost negligible at a position 1 mm away from the optical connector 10.

Therefore, it was confirmed that magnetic influence was negligible in the case where two receptacles were adjacently mounted on a single substrate or the optical module 500 as shown in FIG. 12.

In the present invention, the optical connector 10 corresponds to the “optical connector”, the receptacle 100 corresponds to the “receptacle”, the plug 200 corresponds to the “plug”, the plate-shaped ferrule 110 corresponds to the “first plate-shaped ferrule”, the plate-shaped ferrule 210 corresponds to the “second plate-shaped ferrule”, the connection plate 220 corresponds to the “connection plate”, the magnet 230, the first magnet 231, and the second magnet 232 correspond to the “magnet”, the yoke 240, the first yoke 241, and the second yoke 242 correspond to the “yoke”, the protection component 250 corresponds to the “protection component”, and the boot 260 corresponds to the “boot” and the substrate 550 corresponds to the “electronic substrate”.

The preferred embodiments of the present invention are as described above, though the present invention is not limited thereto. It should be understood that other various embodiments are carried out without departing from the spirit and scope of the present invention. Although the operation and effects by the configuration of the present invention have been described in the embodiments, the operation and effects are merely exemplary and are not intended to limit the present invention.

Reference Signs List

| | |
|---|---|
| 10 | optical connector |
| 100 | receptacle |
| 102 | recess portion |
| 103 | hole portion |
| 104 | connection surface |
| 120 | guide pin |
| 130 | pin keeper |
| 110, 210 | plate-shaped ferrule |
| 200 | plug |
| 220 | connection plate |
| 222 | recess portion |
| 223 | hole portion |
| 224 | slit |
| 225 | connection surface |
| 230 | magnet |
| 231 | first magnet |
| 232 | second magnet |
| 240 | yoke |
| 241 | first yoke |
| 242 | second yoke |
| 250 | protection component |
| 260 | boot |
| 140, 270 | optical fiber |
| 550 | substrate |

1. An optical connector in which a receptacle and a plug are connectable,
wherein the receptacle is a magnetic body and comprises a first plate-shaped ferrule on a connection surface,
the plug comprises a connection plate and a magnet, where the connection plate comprises a second plate-shaped ferrule on a connection surface and the magnet can attract the receptacle via the connection plate, and
the connection plate transmits a magnetic force of the magnet to the receptacle, and applies a pressing force from a rear side of the second plate-shaped ferrule.

2. The optical connector according to claim 1,
wherein the magnet includes a first magnet and a second magnet which have an N pole and an S pole along a longitudinal direction of an optical waveguide component, and which are configured to face each other and to incorporate the optical waveguide component, and
the connection plate is a magnetic body and is arranged so that an attraction force acts between the first and second magnets and the receptacle.

3. The optical connector according to claim 2,
wherein the plug further comprises a yoke arranged on a side of the magnet opposite to the connection plate, and
the yoke is a magnetic body and is arranged so that an attraction force acts between the first and second magnets.

4. The optical connector according to claim 2, wherein the connection plate comes into contact with the first magnet and the second magnet, and a slit is formed between the contact portion of the first magnet and the contact portion of the second magnet.

5. The optical connector according to claim 1,
wherein a length of one side of the first plate-shaped ferrule is 50% or more of a length of one side of the connection plate, and
a length of another side that is perpendicular to the one side of the first plate-shaped ferrule is 50% or more of a length of another side that is perpendicular to the one side of the connection plate.

6. The optical connector according to claim 1,
wherein the plug further comprises a protection component which is adjacent to the connection plate and which has an insertion hole into which the optical waveguide component can be inserted, and a boot which retains in parallel a plurality of optical waveguide components extending from the second plate-shaped ferrule,
the first plate-shaped ferrule and the second plate-shaped ferrule each have an insertion hole in which the plurality of optical waveguide components are mountable and a guide hole for insertion of a guide pin,
the receptacle has a recess portion for fitting the first plate-shaped ferrule and a hole portion into which the optical waveguide components can be inserted,
the connection plate has a recess portion for fitting the second plate-shaped ferrule and a hole into through which the optical waveguide components can be inserted, and
the magnets are arranged symmetrically with respect to a longitudinal central axis of the optical waveguide components and the magnets are in a U-shape.

7. The optical connector according to claim 1, wherein the connection plate has a thickness of 0.3 mm or more to 5 mm or less.

8. The optical connector according to claim 1, wherein the first plate-shaped ferrule and the second plate-shaped ferrule are constituted of a machinable ceramic with a thickness of 0.3 mm or more to 3 mm or less.

9. The optical connector according to claim 4,
wherein the first magnet and the second magnet are spaced apart symmetrically with respect to a longitudinal central axis of the optical waveguide component, and
the slit has a width that is equal to a distance of a gap between the first magnet and the second magnet and is provided from each of an upper end portion and a lower end portion of the connection plate to a position of the second plate-shaped ferrule.

10. The optical connector according to claim 6,
wherein the protection component is formed of a non-magnetic material and has, on an upper surface and a lower surface, protruding portions protruding in parallel to the longitudinal central axis of the optical waveguide components, and
the protruding portions are formed so as to further extend from an end portion of the protection component and are configured to be inserted into the slit.

11. The optical connector according to claim 1,
wherein the connection plate has a recess portion on the connection surface, and
the second plate-shaped ferrule is fitted into the recess portion and is applied with a pressing force from a rear side.

12. The optical connector according to claim 1,
wherein a separation distance between the connection surface of the receptacle and the connection surface of the connection plate is 0.5 mm or less, and
the number of fibers of the optical waveguide component to be connected in each of the first plate-shaped ferrule and the second plate-shaped ferrule is 8 or more to 80 or less.

13. An optical module which is connectable to the optical connector according to claim 1, wherein the optical module comprising the receptacle.

14. The optical connector according to claim 1,
wherein the plug is connectable to the receptacle.

15. A method for connecting the optical connector according to claim 1, wherein the method comprising connecting the receptacle and the plug.
